(19) United States
(12) Patent Application Publication
(10) Pub. No.: US 2026/0238290 A1
(43) Pub. Date: Aug. 13, 2026

(54) COLLISION HANDLING FOR SUB-BAND FULL DUPLEX SETS OF SYMBOLS

(71) Applicant: QUALCOMM Incorporated, San Diego, CA (US)

(72) Inventors: Prashant SHARMA, San Marcos, CA (US); Muhammad Sayed Khairy ABDELGHAFFAR, San Jose, CA (US); Jae Ho RYU, San Diego, CA (US)

(21) Appl. No.: 19/462,069

(22) Filed: Jan. 28, 2026

Related U.S. Application Data
(60) Provisional application No. 63/755,668, filed on Feb. 7, 2025.

(51) Int. Cl. H04B 7/06; H04L 5/14; H04W 72/21; H04W 76/15

(52) U.S. Cl. CPC H04B 7/0626; H04L 5/14; H04W 72/21; H04W 76/15

(57) ABSTRACT

Various aspects of the present disclosure generally relate to wireless communication. In some aspects, a user equipment (UE) may receive configuration information that indicates channel state information reference signal (CSI-RS) resources that are within a downlink sub-band of a sub-band full duplex (SBFD) set of symbols, wherein the CSI-RS resources are associated with layer 1 (L1) measurements. The UE may receive a first indication that the UE is to perform an uplink transmission in an uplink sub-band of the SBFD set of symbols. The UE may selectively perform, based at least in part on the configuration information and the first indication, one of the L1 measurements using the CSI-RS resources in the downlink sub-band of the SBFD set of symbols, or the uplink transmission using the uplink sub-band of the SBFD set of symbols. Numerous other aspects are described.

### CROSS-REFERENCE TO RELATED APPLICATION

This Patent Application claims priority to U.S. Provisional Patent Application No. 63/755,668, filed on February 7, 2025, entitled “COLLISION HANDLING FOR SUB-BAND FULL DUPLEX SETS OF SYMBOLS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with collision handling for sub-band full duplex sets of symbols.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some examples, wireless communication devices may be capable of sub-band full duplex (SBFD) communication, which may also be referred to as “sub-band frequency division duplex (SBFDD)” or “flexible duplex.” In SBFD at a network node side, a first user equipment (UE) may transmit an uplink communication to a network node using an uplink sub-band of a SBFD set of symbols and a second UE may receive a downlink communication from the network node using a downlink sub-band of the SBFD set of symbols. In some examples, frequency resources used for downlink communication (e.g., the downlink sub-band of the SBFD set of symbols) may be separated from frequency resources used for uplink communication (e.g., the uplink sub-band of the SBFD set of symbols), in the frequency domain, by a guard band.

### SUMMARY

Some aspects described herein relate to a method of wireless communication performed by a user equipment (UE). The method may include receiving configuration information that indicates channel state information reference signal (CSI-RS) resources that are within a downlink sub-band of a sub-band full duplex (SBFD) set of symbols, wherein the CSI-RS resources are associated with layer 1 (L1) measurements. The method may include receiving a first indication that the UE is to perform an uplink transmission in an uplink sub-band of the SBFD set of symbols. The method may include selectively performing, based at least in part on the configuration information and the first indication, one of the L1 measurements using the CSI-RS resources in the downlink sub-band of the SBFD set of symbols, or the uplink transmission using the uplink sub-band of the SBFD set of symbols.

Some aspects described herein relate to a method of wireless communication performed by a UE. The method may include receiving configuration information that indicates a CSI-RS resource configuration that indicates resources for performing CSI-RS measurements, and an SBFD transmit/reception configuration that indicates whether the UE is to transmit or receive communications across SBFD symbols and non-SBFD symbols. The method may include performing, based at least in part on the configuration information, the CSI-RS measurements using at least one of one or more non-SBFD symbols, or a downlink sub-band of one or more SBFD symbols.

Some aspects described herein relate to a method of wireless communication performed by a network node. The method may include transmitting, to a UE, configuration information that indicates CSI-RS resources that are within a downlink sub-band of an SBFD set of symbols, wherein the CSI-RS resources are associated with L1 measurements. The method may include transmitting, to the UE, a first indication that the UE is to perform an uplink transmission in an uplink sub-band of the SBFD set of symbols. The method may include receiving, from the UE and based at least in part on the configuration information and the first indication, one of the L1 measurements using the CSI-RS resources in the downlink sub-band of the SBFD set of symbols, or the uplink transmission using the uplink sub-band of the SBFD set of symbols.

Some aspects described herein relate to a method of wireless communication performed by a network node. The method may include transmitting, to a UE, configuration information that indicates a CSI-RS resource configuration that indicates resources for performing CSI-RS measurements, and an SBFD transmit/reception configuration that indicates whether the UE is to transmit or receive communications across SBFD symbols and non-SBFD symbols. The method may include receiving, from the UE and based at least in part on the configuration information, CSI-RS measurement results associated with CSI-RS measurements using at least one of one or more non-SBFD symbols, or a downlink sub-band of one or more SBFD symbols.

Some aspects described herein relate to a UE. The UE may include a processing system. The processing system may include one or more processors and one or more code-storing memories coupled with the one or more processors. The processing system may be configured to cause the UE to receive configuration information that indicates CSI-RS resources that are within a downlink sub-band of an SBFD set of symbols, wherein the CSI-RS resources are associated with L1 measurements. The processing system may be configured to cause the UE to receive a first indication that the UE is to perform an uplink transmission in an uplink sub-band of the SBFD set of symbols. The processing system may be configured to cause the UE to selectively perform, based at least in part on the configuration information and the first indication, one of the L1 measurements using the CSI-RS resources in the downlink sub-band of the SBFD set of symbols, or the uplink transmission using the uplink sub-band of the SBFD set of symbols.

Some aspects described herein relate to a UE. The UE may include a processing system. The processing system may include one or more processors and one or more code-storing memories coupled with the one or more processors. The processing system may be configured to cause the UE to receive configuration information that indicates a CSI-RS resource configuration that indicates resources for performing CSI-RS measurements, and an SBFD transmit/reception configuration that indicates whether the UE is to transmit or receive communications across SBFD symbols and non-SBFD symbols. The processing system may be configured to cause the UE to perform, based at least in part on the configuration information, the CSI-RS measurements using at least one of one or more non-SBFD symbols, or a downlink sub-band of one or more SBFD symbols.

Some aspects described herein relate to a network node. The network node may include a processing system. The processing system may include one or more processors and one or more code-storing memories coupled with the one or more processors. The processing system may be configured to cause the network node to transmit, to a UE, configuration information that indicates CSI-RS resources that are within a downlink sub-band of an SBFD set of symbols, wherein the CSI-RS resources are associated with L1 measurements. The processing system may be configured to cause the network node to transmit, to the UE, a first indication that the UE is to perform an uplink transmission in an uplink sub-band of the SBFD set of symbols. The processing system may be configured to cause the network node to receive, from the UE and based at least in part on the configuration information and the first indication, one of the L1 measurements using the CSI-RS resources in the downlink sub-band of the SBFD set of symbols, or the uplink transmission using the uplink sub-band of the SBFD set of symbols.

Some aspects described herein relate to a network node. The network node may include a processing system. The processing system may include one or more processors and one or more code-storing memories coupled with the one or more processors. The processing system may be configured to cause the network node to transmit, to a UE, configuration information that indicates a CSI-RS resource configuration that indicates resources for performing CSI-RS measurements, and an SBFD transmit/reception configuration that indicates whether the UE is to transmit or receive communications across SBFD symbols and non-SBFD symbols. The processing system may be configured to cause the network node to receive, from the UE and based at least in part on the configuration information, CSI-RS measurement results associated with CSI-RS measurements using at least one of one or more non-SBFD symbols, or a downlink sub-band of one or more SBFD symbols.

Some aspects described herein relate to a non-transitory computer-readable medium that stores a set of instructions for wireless communication by a UE. The set of instructions, when executed by one or more processors of the UE, may cause the UE to receive configuration information that indicates CSI-RS resources that are within a downlink sub-band of an SBFD set of symbols, wherein the CSI-RS resources are associated with L1 measurements. The set of instructions, when executed by one or more processors of the UE, may cause the UE to receive a first indication that the UE is to perform an uplink transmission in an uplink sub-band of the SBFD set of symbols. The set of instructions, when executed by one or more processors of the UE, may cause the UE to selectively perform, based at least in part on the configuration information and the first indication, one of the L1 measurements using the CSI-RS resources in the downlink sub-band of the SBFD set of symbols, or the uplink transmission using the uplink sub-band of the SBFD set of symbols.

Some aspects described herein relate to a non-transitory computer-readable medium that stores a set of instructions for wireless communication by a one or more instructions that, when executed by one or more processors of an UE. The set of instructions, when executed by one or more processors of the UE, may cause the UE to receive configuration information that indicates a CSI-RS resource configuration that indicates resources for performing CSI-RS measurements, and an SBFD transmit/reception configuration that indicates whether the UE is to transmit or receive communications across SBFD symbols and non-SBFD symbols. The set of instructions, when executed by one or more processors of the UE, may cause the UE to perform, based at least in part on the configuration information, the CSI-RS measurements using at least one of one or more non-SBFD symbols, or a downlink sub-band of one or more SBFD symbols.

Some aspects described herein relate to a non-transitory computer-readable medium that stores a set of instructions for wireless communication by a network node. The set of instructions, when executed by one or more processors of the network node, may cause the network node to transmit, to a UE, configuration information that indicates CSI-RS resources that are within a downlink sub-band of an SBFD set of symbols, wherein the CSI-RS resources are associated with L1 measurements. The set of instructions, when executed by one or more processors of the network node, may cause the network node to transmit, to the UE, a first indication that the UE is to perform an uplink transmission in an uplink sub-band of the SBFD set of symbols. The set of instructions, when executed by one or more processors of the network node, may cause the network node to receive, from the UE and based at least in part on the configuration information and the first indication, one of the L1 measurements using the CSI-RS resources in the downlink sub-band of the SBFD set of symbols, or the uplink transmission using the uplink sub-band of the SBFD set of symbols.

Some aspects described herein relate to a non-transitory computer-readable medium that stores a set of instructions for wireless communication by a network node. The set of instructions, when executed by one or more processors of the network node, may cause the network node to transmit, to a UE, configuration information that indicates a CSI-RS resource configuration that indicates resources for performing CSI-RS measurements, and an SBFD transmit/reception configuration that indicates whether the UE is to transmit or receive communications across SBFD symbols and non-SBFD symbols. The set of instructions, when executed by one or more processors of the network node, may cause the network node to receive, from the UE and based at least in part on the configuration information, CSI-RS measurement results associated with CSI-RS measurements using at least one of one or more non-SBFD symbols, or a downlink sub-band of one or more SBFD symbols.

Some aspects described herein relate to an apparatus for wireless communication. The apparatus may include means for receiving configuration information that indicates CSI-RS resources that are within a downlink sub-band of an SBFD set of symbols, wherein the CSI-RS resources are associated with L1 measurements. The apparatus may include means for receiving a first indication that the apparatus is to perform an uplink transmission in an uplink sub-band of the SBFD set of symbols. The apparatus may include means for selectively performing, based at least in part on the configuration information and the first indication, one of the L1 measurements using the CSI-RS resources in the downlink sub-band of the SBFD set of symbols, or the uplink transmission using the uplink sub-band of the SBFD set of symbols.

Some aspects described herein relate to an apparatus for wireless communication. The apparatus may include means for receiving configuration information that indicates a CSI-RS resource configuration that indicates resources for performing CSI-RS measurements, and an SBFD transmit/reception configuration that indicates whether the apparatus is to transmit or receive communications across SBFD symbols and non-SBFD symbols. The apparatus may include means for performing, based at least in part on the configuration information, the CSI-RS measurements using at least one of one or more non-SBFD symbols, or a downlink sub-band of one or more SBFD symbols.

Some aspects described herein relate to an apparatus for wireless communication. The apparatus may include means for transmitting, to a UE, configuration information that indicates CSI-RS resources that are within a downlink sub-band of an SBFD set of symbols, wherein the CSI-RS resources are associated with L1 measurements. The apparatus may include means for transmitting, to the UE, a first indication that the UE is to perform an uplink transmission in an uplink sub-band of the SBFD set of symbols. The apparatus may include means for receiving, from the UE and based at least in part on the configuration information and the first indication, one of, the L1 measurements using the CSI-RS resources in the downlink sub-band of the SBFD set of symbols, or the uplink transmission using the uplink sub-band of the SBFD set of symbols.

Some aspects described herein relate to an apparatus for wireless communication. The apparatus may include means for transmitting, to a UE, configuration information that indicates a CSI-RS resource configuration that indicates resources for performing CSI-RS measurements, and an SBFD transmit/reception configuration that indicates whether the UE is to transmit or receive communications across SBFD symbols and non-SBFD symbols. The apparatus may include means for receiving, from the UE and based at least in part on the configuration information, CSI-RS measurement results associated with CSI-RS measurements using at least one of one or more non-SBFD symbols, or a downlink sub-band of one or more SBFD symbols.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating examples of full-duplex communication in a wireless network.

FIG. 4 is a diagram illustrating an example of slot structures associated with sub-band full duplex (SBFD) schemes.

FIGS. 5A-5B are diagrams of examples associated with collision handling for SBFD sets of symbols.

FIGS. 6A-6B are diagrams of examples associated with channel state information reference signal measurements across SBFD symbols and non-SBFD symbols.

FIG. 7 is a diagram illustrating an example process performed, for example, at a user equipment (UE) or an apparatus of a UE.

FIG. 8 is a diagram illustrating another example process performed, for example, at a UE or an apparatus of a UE.

FIG. 9 is a diagram illustrating an example process performed, for example, at a network node or an apparatus of a network node.

FIG. 10 is a diagram illustrating another example process performed, for example, at a network node or an apparatus of a network node.

FIG. 11 is a diagram of an example apparatus for wireless communication.

FIG. 12 is a diagram of another example apparatus for wireless communication.

### DETAILED DESCRIPTION

In some examples, wireless communication may be associated with sub-band full duplex (SBFD) operation, which implies simultaneous transmission and reception of downlink communications and uplink communications on a sub-band basis at a network node. In SBFD symbols, a network node may dynamically configure an SBFD-aware user equipment (UE) to transmit in the uplink sub-band of an SBFD set of symbols while other UEs simultaneously receive downlink communication in one or more downlink sub-bands of the SBFD set of symbols, among other examples.

In some examples, a network node may configure a UE to perform measurements associated with layer (L1) procedures (sometimes referred to herein as L1 measurements). For example, the network node may configure the UE to perform channel state information (CSI) reference signal (CSI-RS) based measurements for one or more L1 procedures. When the UE is configured to operate in an SBFD mode or is configured with one or more SBFD configurations, some of the configured CSI-RS resources for L1 measurements may collide (e.g., at least partially overlap, in a time domain) with a dynamically scheduled uplink transmission in an SBFD set of symbols (e.g., an uplink sub-band of an SBFD set of symbols). In such examples, an SBFD-aware UE may be aware of a collision between the CSI-RS resources and the dynamically scheduled uplink transmission, but may otherwise be unaware of how to handle the collision (e.g., the UE may not be specified or configured with a rule for handling the collision). Accordingly, whether a particular UE receives or transmits a particular communication in a collision scenario may be left to UE implementation. This may result in a UE forgoing certain high-priority L1 measurements or uplink transmissions, or else a UE selectively performing L1 measurements or uplink transmissions in a transparent manner to the network node, leading to increased communication errors; high power, computing, and network resource consumption for purposes of correcting communication errors; increased latency and reduced throughput associated with communication channels between a network node and a UE; and otherwise inefficient usage of network resources.

Additionally, or alternatively, in some examples a network node may configure a UE with an SBFD transmit/reception configuration, which may indicate how a UE is to handle uplink or downlink communications across SBFD and non-SBFD sets of symbols. For example, for uplink transmissions and downlink receptions across SBFD symbols and non-SBFD symbols in different slots, an SBFD-aware UE may be provided with a first configuration (sometimes referred to herein as “configuration 1”), in which the transmissions/receptions are restricted to SBFD symbols only or non-SBFD symbols only, or else a second configuration (sometimes referred to herein as “configuration 2”), in which the transmissions/receptions may be in SBFD symbols and non-SBFD symbols. In such examples, an SBFD-aware UE may be unaware of how treat or measure CSI-RS resources extending across SBFD sets of symbols and non-SBFD sets of symbols. Accordingly, whether a particular UE measures a particular CSI-RS resource instance may be left to UE implementation. This may result in a UE forgoing certain high-priority L1 measurements, or else a UE selectively performing L1 measurements in a transparent manner to the network node, leading to increased communication errors; high power, computing, and network resource consumption for purposes of correcting communication errors; increased latency and reduced throughput associated with communication channels between a network node and a UE; and otherwise inefficient usage of network resources.

Various aspects relate generally to enhanced collision handling for SBFD-aware UEs, such as enhanced collision handling for CSI-RS-based L1 measurements and dynamically scheduled uplink transmissions. Additionally, or alternatively, various aspects relate to enhanced CSI-RS-based measurements configurations, such as measurements of CSI-RS resources that extend across SBFD and non-SBFD sets of symbols. In some aspects, a UE may receive configuration information that indicates CSI-RS resources for performing L1 measurements that are within a downlink sub-band of an SBFD set of symbols and a dynamic indication to perform an uplink transmission in an uplink sub-band of the SBFD set of symbols. The UE may selectively perform (e.g., based at least in part on an indication received from a network node, a predefined rule, or certain criteria such as a previous L1 measurement satisfying a threshold, among other examples), one of the L1 measurements using the CSI-RS resources in the downlink sub-band of the SBFD set of symbols or the uplink transmission using the uplink sub-band of the SBFD set of symbols. Additionally, or alternatively, the UE may receive configuration information that indicates a CSI-RS resource configuration and an SBFD transmit/reception configuration that indicates whether the UE is to transmit or receive communications across SBFD symbols and non-SBFD symbols. Based at least in part on the configuration information, a predefined rule, an indication received from a network node, or similar information, the UE may perform the CSI-RS measurements using at least one of one or more non-SBFD symbols or a downlink sub-band of one or more SBFD symbols.

Particular aspects of the subject matter described in this disclosure can be implemented to realize one or more of the following potential advantages. In some examples, the described techniques can be used to enable the UE and the network node to communicate with more transparency or exchange control information or other high-priority traffic, thus communicating with decreased communication errors. As a result, the aspects of the subject matter described in this disclosure can be implemented to realize reduced power, computing, and network resource consumption otherwise used for purposes of correcting communication errors; decreased latency and increased throughput associated with communication channels between the network node and the UE; and otherwise more efficient usage of network resources.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

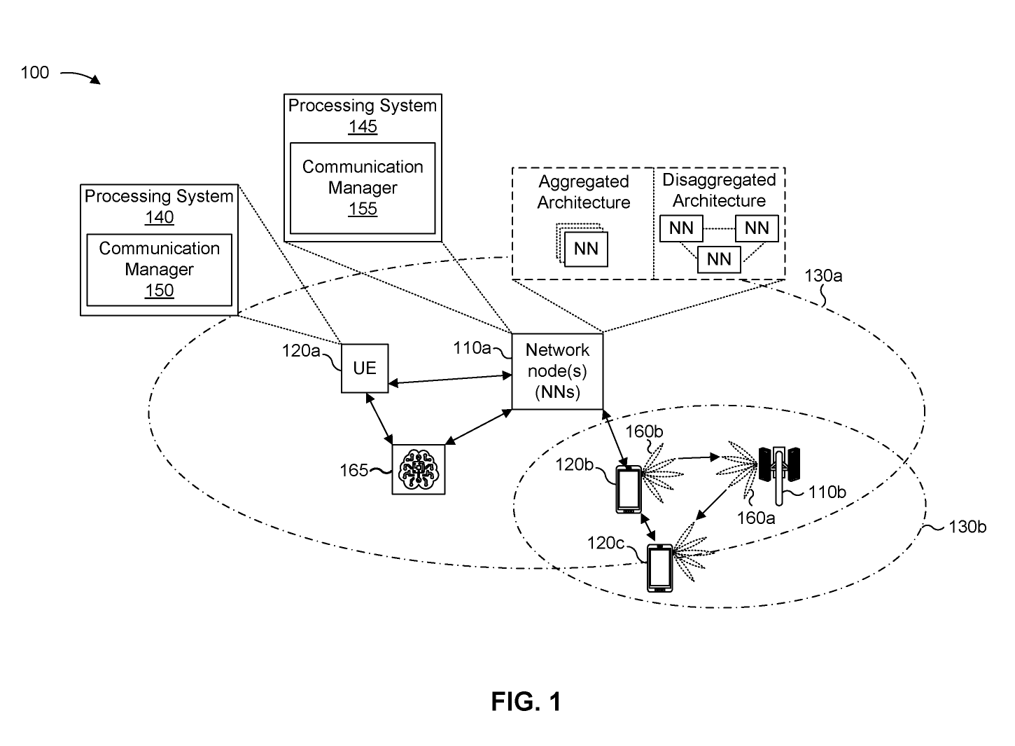

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI-RS, among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, an L1- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

A network node 110 or a UE 120 operating in a half-duplex mode may perform only one of transmission or reception during particular time resources, such as during particular slots, symbols, or other time periods. In various examples, some of the network nodes 110 and the UEs 120 of the wireless communication network 100 may be configured for full-duplex operation in addition to half-duplex operation. In full-duplex operation, a network node 110 or a UE 120 operating in a full-duplex (for example, SBFD) mode can transmit and receive communications concurrently (for example, in the same time resources). For example, as shown in FIG. 1, the network node 110b may operate in the full-duplex mode. The network node 110b may concurrently receive uplink communications from the UE 120b and transmit downlink communications to the UE 120c. By operating in a full-duplex mode, network nodes 110 or UEs 120 may generally increase the capacity of the network and the radio access link. In some examples, full-duplex operation may involve frequency division duplexing (FDD), in which downlink transmissions of the network node 110b are performed in a first frequency band or on a first component carrier and transmissions of the UE 120b are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an uplink transmission to a first network node 110 and receive a downlink transmission from a second network node 110 in the same time resources. In some other examples, full-duplex operation may be enabled for a network node 110 but not for a UE 120. For example, the network node 110b may simultaneously transmit a downlink transmission to a first UE 120 (for example, the UE 120c) and receive an uplink transmission from a second UE 120 (for example, the UE 120b) in the same time resources. In some other examples, full-duplex operation may be enabled for both a network node 110 and a UE 120.

Further efficiencies in throughput, signal strength, or other signal properties may be achieved through beam refinement. For example, the network node 110 may be capable of communicating with the UE 120 using beams (for example, beam(s) 160a) of different beam widths. In some examples, the network node 110 may be configured to utilize a wider beam to communicate with the UE 120 when the UE 120 is in motion or for initial beam acquisition because wider coverage may increase the likelihood that the mobile UE 120 remains in coverage of the network node 110 while communicating using the wider beam. Conversely, the network node 110 may use a narrower beam to communicate with the UE 120 when the UE 120 is stationary because the network node 110 can reliably focus coverage on the UE 120 with low or minimal likelihood of the UE 120 moving out of the coverage area of the narrower beam. In some examples, to select a particular beam (for example, from the beam(s) 160a) for communication with a UE 120, the network node 110 may transmit a reference signal, such as an SSB or a CSI-RS, on each of a plurality of beams in a beam-sweeping manner. In some examples, SSBs may be transmitted on wider beams, whereas CSI-RSs may be transmitted on narrower beams. The UE 120 may measure the RSRP or the signal-to-interference-plus-noise ratio (SINR) on each of the beams and transmit a beam measurement report (for example, an L1 measurement report) to the network node 110 indicating the RSRP or SINR associated with each of one or more of the measured beams. The network node 110 may then select the particular beam for communication with the UE 120 based on the L1 measurement report. In some other examples, when there is channel reciprocity between the uplink and the downlink, the network node 110 may derive the particular beam to communicate with the UE 120 (for example, on both the uplink and downlink) based on uplink measurements of one or more uplink reference signals, such as an SRS, transmitted by the UE 120.

In some aspects, the UE 120 may include a communication manager 150. As described in more detail elsewhere herein, the communication manager 150 may receive configuration information that indicates CSI-RS resources that are within a downlink sub-band of an SBFD set of symbols, wherein the CSI-RS resources are associated with L1 measurements; receive a first indication that the UE is to perform an uplink transmission in an uplink sub-band of the SBFD set of symbols; and selectively perform, based at least in part on the configuration information and the first indication, one of: the L1 measurements using the CSI-RS resources in the downlink sub-band of the SBFD set of symbols, or the uplink transmission using the uplink sub-band of the SBFD set of symbols. Additionally, or alternatively, the communication manager 150 may receive configuration information that indicates: a CSI-RS resource configuration that indicates resources for performing CSI-RS measurements, and an SBFD transmit/reception configuration that indicates whether the UE is to transmit or receive communications across SBFD symbols and non-SBFD symbols; and perform, based at least in part on the configuration information, the CSI-RS measurements using at least one of one or more non-SBFD symbols, or a downlink sub-band of one or more SBFD symbols. Additionally, or alternatively, the communication manager 150 may perform one or more other operations described herein.

In some aspects, the network node 110 may include a communication manager 155. As described in more detail elsewhere herein, the communication manager 155 may transmit, to a UE, configuration information that indicates CSI-RS resources that are within a downlink sub-band of an SBFD set of symbols, wherein the CSI-RS resources are associated with L1 measurements; transmit, to the UE, a first indication that the UE is to perform an uplink transmission in an uplink sub-band of the SBFD set of symbols; and receive, from the UE and based at least in part on the configuration information and the first indication, one of: the L1 measurements using the CSI-RS resources in the downlink sub-band of the SBFD set of symbols, or the uplink transmission using the uplink sub-band of the SBFD set of symbols. Additionally, or alternatively, the communication manager 155 may transmit, to a UE, configuration information that indicates: a CSI-RS resource configuration that indicates resources for performing CSI-RS measurements, and an SBFD transmit/reception configuration that indicates whether the UE is to transmit or receive communications across SBFD symbols and non-SBFD symbols; and receive, from the UE and based at least in part on the configuration information, CSI-RS measurement results associated with CSI-RS measurements using at least one of one or more non-SBFD symbols, or a downlink sub-band of one or more SBFD symbols. Additionally, or alternatively, the communication manager 155 may perform one or more other operations described herein.

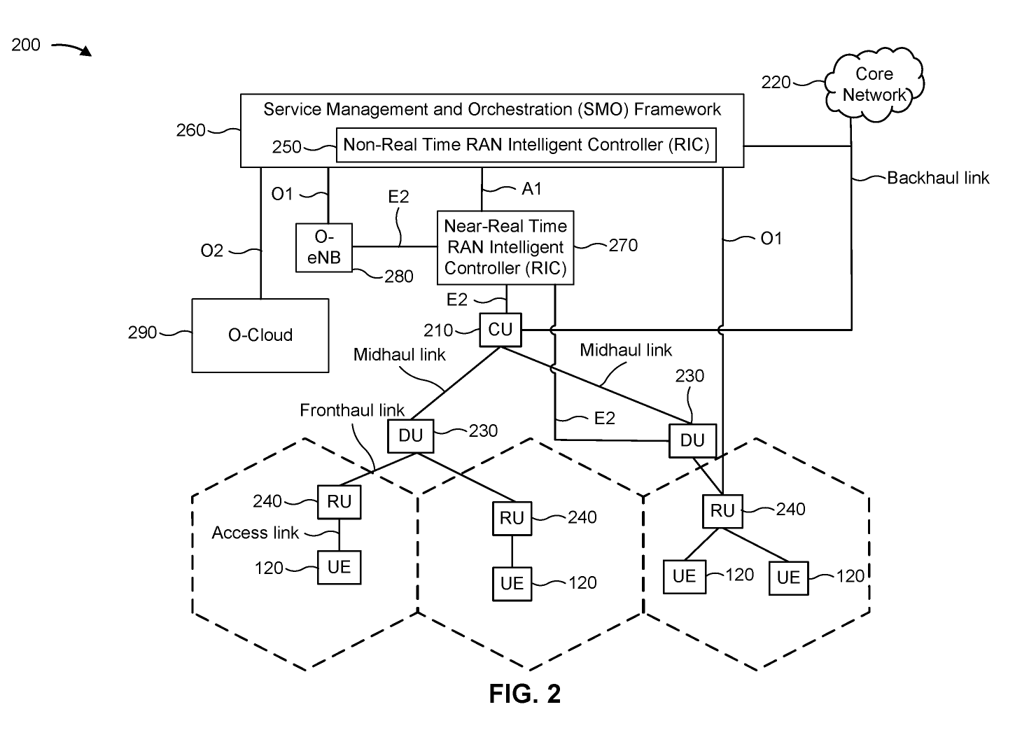

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

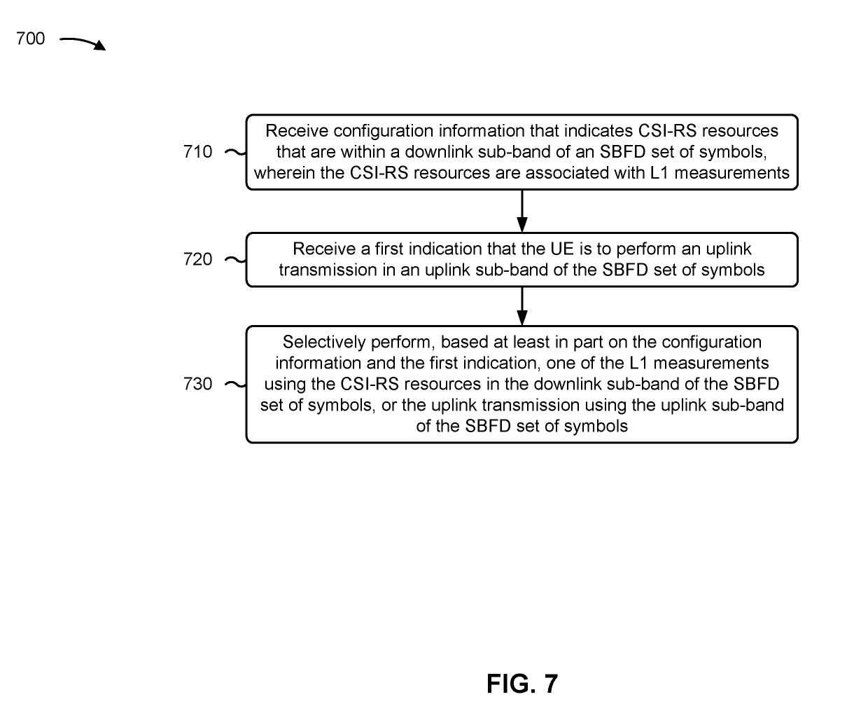

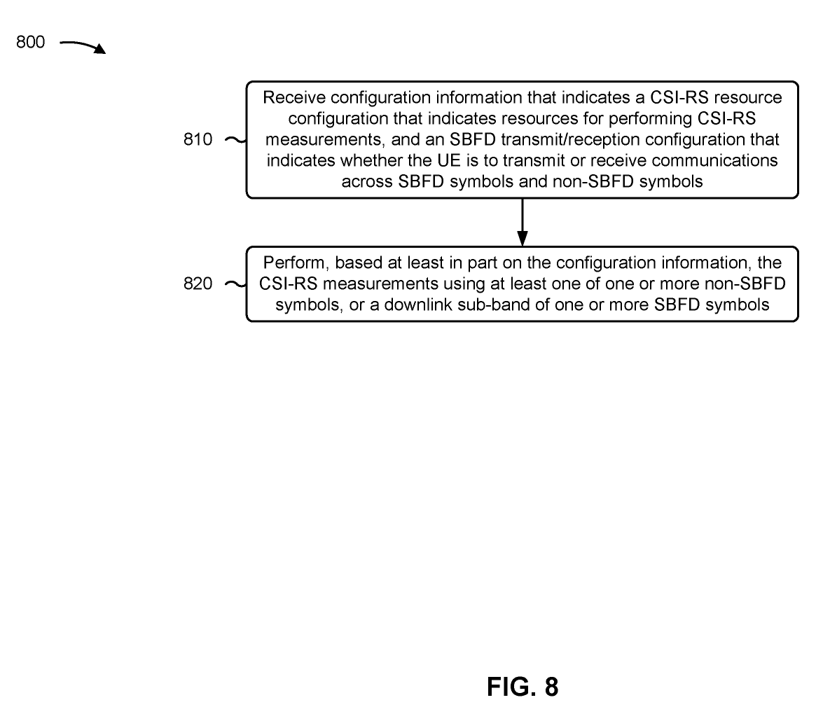

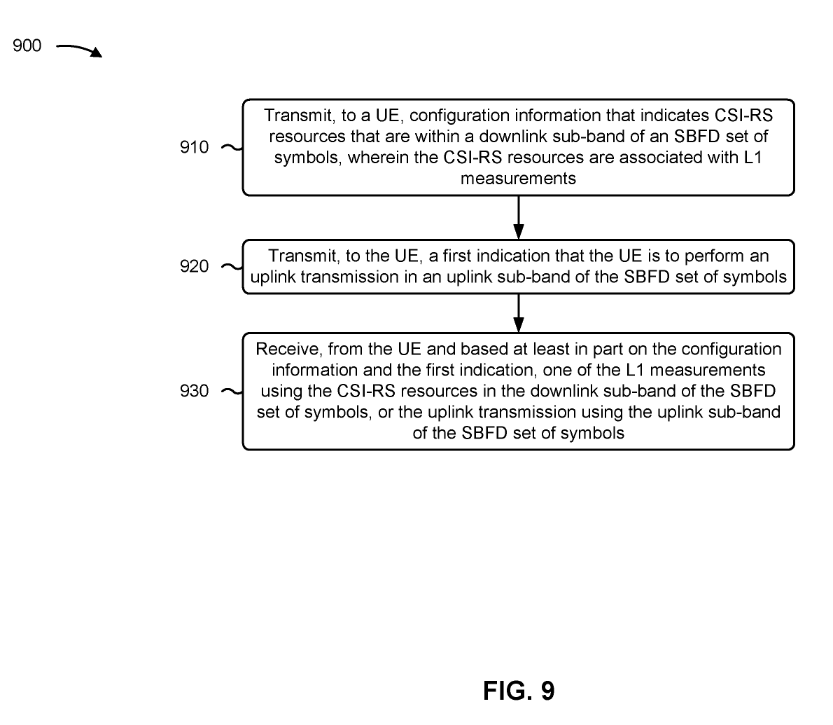

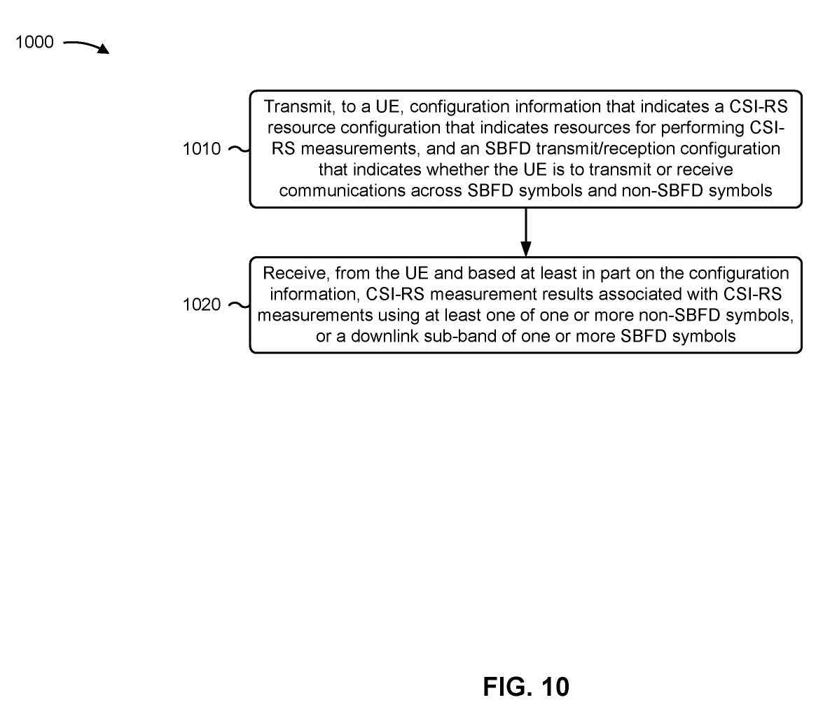

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with collision handling for SBFD sets of symbols, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, process 900 of FIG. 9, process 1000 of FIG. 10, or other processes as described herein. In some examples, executing instructions may include running the instructions, converting the instructions, compiling the instructions, or interpreting the instructions, among other examples.

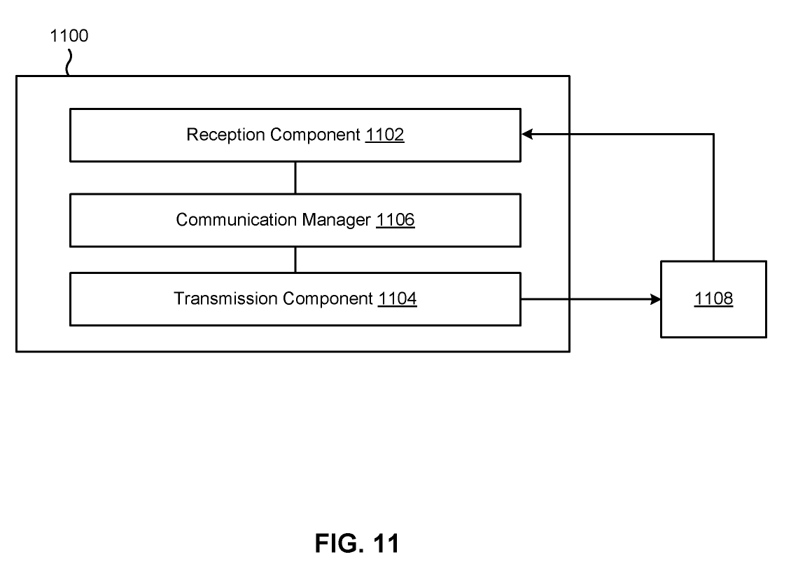

In some aspects, the UE 120 includes means for receiving configuration information that indicates CSI-RS resources that are within a downlink sub-band of an SBFD set of symbols, wherein the CSI-RS resources are associated with L1 measurements; means for receiving a first indication that the UE is to perform an uplink transmission in an uplink sub-band of the SBFD set of symbols; or means for selectively performing, based at least in part on the configuration information and the first indication, one of: the L1 measurements using the CSI-RS resources in the downlink sub-band of the SBFD set of symbols, or the uplink transmission using the uplink sub-band of the SBFD set of symbols. Additionally, or alternatively, in some aspects, the UE 120 includes means for receiving configuration information that indicates: a CSI-RS resource configuration that indicates resources for performing CSI-RS measurements, and an SBFD transmit/reception configuration that indicates whether the UE is to transmit or receive communications across SBFD symbols and non-SBFD symbols; or means for performing, based at least in part on the configuration information, the CSI-RS measurements using at least one of one or more non-SBFD symbols, or a downlink sub-band of one or more SBFD symbols. The means for the UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

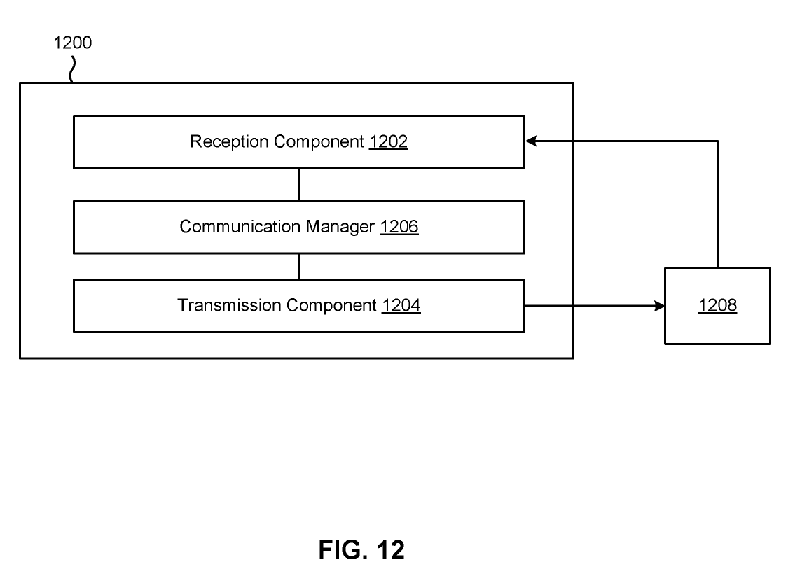

In some aspects, the network node 110 includes means for transmitting, to a UE, configuration information that indicates CSI-RS resources that are within a downlink sub-band of an SBFD set of symbols, wherein the CSI-RS resources are associated with L1 measurements; means for transmitting, to the UE, a first indication that the UE is to perform an uplink transmission in an uplink sub-band of the SBFD set of symbols; or means for receiving, from the UE and based at least in part on the configuration information and the first indication, one of: the L1 measurements using the CSI-RS resources in the downlink sub-band of the SBFD set of symbols, or the uplink transmission using the uplink sub-band of the SBFD set of symbols. Additionally, or alternatively, in some aspects, the network node 110 includes means for transmitting, to a UE, configuration information that indicates: a CSI-RS resource configuration that indicates resources for performing CSI-RS measurements, and an SBFD transmit/reception configuration that indicates whether the UE is to transmit or receive communications across SBFD symbols and non-SBFD symbols; or means for receiving, from the UE and based at least in part on the configuration information, CSI-RS measurement results associated with CSI-RS measurements using at least one of one or more non-SBFD symbols, or a downlink sub-band of one or more SBFD symbols. The means for the network node 110 to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

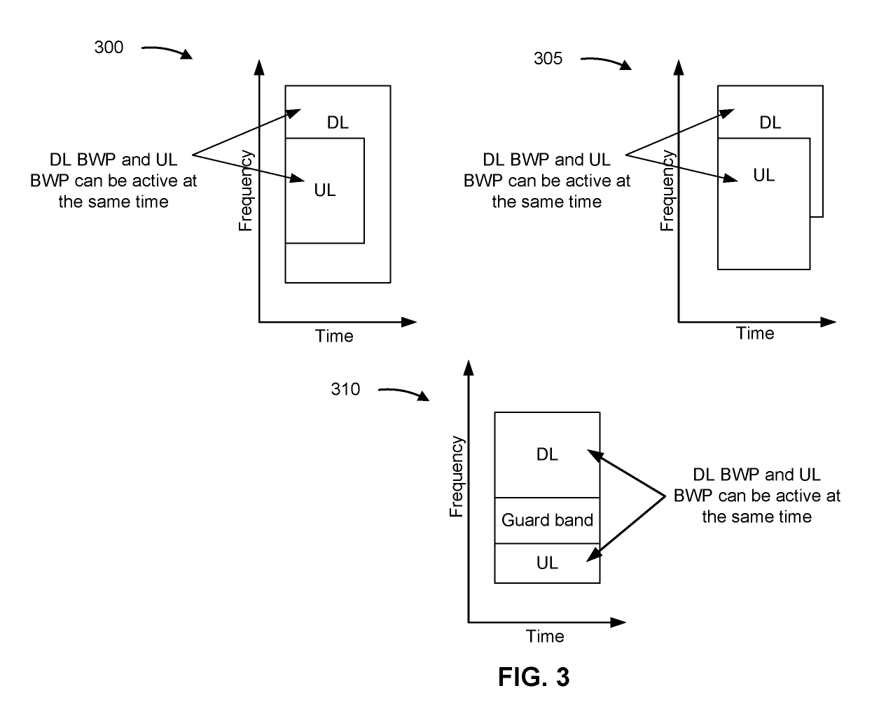

FIG. 3 is a diagram illustrating examples 300, 305, and 310 of full-duplex communication in a wireless network. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 3, examples 300 and 305 show examples of in-band full-duplex (IBFD) communication. In IBFD, a UE may transmit an uplink communication to a network node and receive a downlink communication from the network node on the same time and frequency resources. As shown in example 300, in a first example of IBFD, the time and frequency resources for uplink communication may fully overlap with the time and frequency resources for downlink communication. As shown in example 305, in a second example of IBFD, the time and frequency resources for uplink communication may partially overlap with the time and frequency resources for downlink communication.

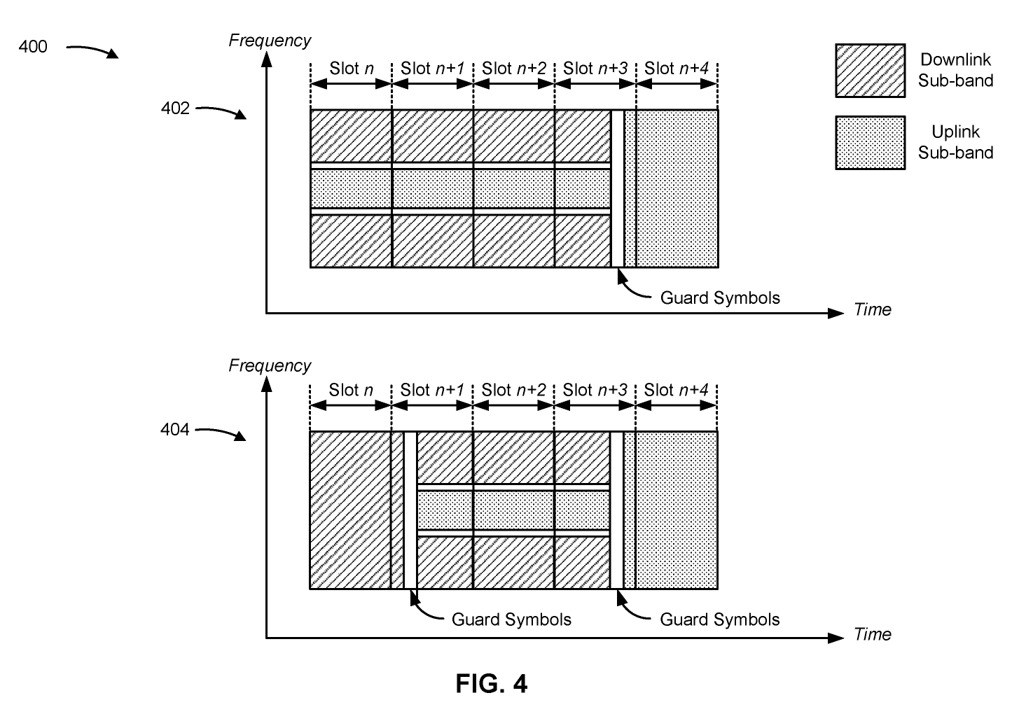

As further shown in FIG. 3, example 310 shows an example of SBFD communication, which may also be referred to as “sub-band frequency division duplex (SBFDD)” or “flexible duplex.” In some examples of SBFD, such as examples involving SBFD operation at the UE side, a UE may transmit an uplink communication to a network node and receive a downlink communication from the network node at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band. In some other examples of SBFD, such as examples involving SBFD operation at the network node side, a first UE may transmit an uplink communication to a network node using an uplink sub-band of an SBFD set of symbols and a second UE may receive a downlink communication from the network node using a downlink sub-band of the SBFD set of symbols. Additional aspects of SBFD are described in more detail below in connection with FIG. 4.

As indicated above, FIG. 3 is provided as an example. Other examples may differ from what is described with respect to FIG. 3.

FIG. 4 is a diagram illustrating an example 400 of slot structures associated with SBFD schemes. In some instances, the example slot structures shown in FIG. 4 may be associated with SBFD operation within a time division duplex (TDD) carrier.

In some examples, SBFD operation implies simultaneous transmission and reception of downlink communications and uplink communications on a sub-band basis at a network node 110. SBFD operation may enable latency reduction by permitting transmission of uplink channels or signals in an uplink sub-band of a semi-statically configured downlink slot or a semi-statically configured flexible slot (sometimes referred to as a “D slot” or an “F” slot, respectively, such as a slot that is semi-statically configured as a D slot or an F slot via a TDD-UL-DL-ConfigCommon parameter or similar configuration parameter) or reception of downlink channels or signals in a downlink sub-band of a semi-statically configured uplink slot (sometimes referred to as a “U slot”) or flexible slot (e.g., F slot). Additionally, or alternatively, SBFD operation may enable uplink coverage enhancement or flexible uplink/downlink resource adaptation according to real-time uplink/downlink traffic. Moreover, in SBFD symbols, a network node may dynamically configure an SBFD-aware UE (a UE for which the network node’s SBFD operation is non-transparent to the UE) to transmit in the uplink sub-band of the SBFD symbols while other UEs may simultaneously receive downlink communication in the one or more downlink sub-bands of the SBFD set of symbols, among other examples.

Reference numbers 402 and 404 show example TDD pattern periods associated with SBFD operation. In the example shown by reference number 402, the TDD pattern period includes five slots (indexed as slot n through slot n+4). Some slots of the example TDD pattern period may include only SBFD symbols (e.g., symbols including a downlink sub-band and an uplink sub-band), and thus may be referred to as SBFD slots. For example, the first three slots of the example TDD pattern period in the example indicated by reference number 402 (e.g., slots n through n+2) are SBFD slots that include a downlink sub-band (shown using hatching) and an uplink sub-band (shown using stippling). As shown in FIG. 4, in some examples one or more sub-bands in an SBFD slot may be non-contiguous sub-bands. For example, the downlink sub-band in the SBFD slots is a non-contiguous sub-band, and thus occupies a top portion of a bandwidth associated with a component carrier and a bottom portion of the bandwidth associated with the component carrier, with the uplink sub-band occupying the middle portion of the bandwidth associated with the component carrier. In some other examples, the uplink sub-band may be a non-contiguous sub-band or both the downlink sub-band and the uplink sub-band may be contiguous sub-bands.

As further shown in the example indicted by reference number 402, some slots of the example TDD pattern period may include only non-SBFD symbols (e.g., downlink-only symbols or uplink-only symbols), and thus may be referred to as non-SBFD slots, downlink-only slots (e.g., D slots), or uplink-only slots (e.g., U slots). For example, the fifth slot (e.g., slot n+4) is an uplink-only slot (e.g., U slot) that includes only uplink symbols. Moreover, some slots may include both SBFD symbols and non-SBFD symbols, and thus may be referred to as a slot with mixed symbols. For example, in the example indicated by reference number 402, the fourth slot (e.g., slot n+3) is a slot with mixed symbols, including SBFD symbols and uplink symbols. In such examples, the slot with mixed symbols may further include guard symbols separating the SBFD symbols from the non-SBFD symbols. Additionally, or alternatively, in some examples, a portion of the TDD frame period associated with switching between SBFD symbols and non-SBFD symbols (e.g., the portion of the TDD frame period associated with the guard symbols in the example indicated by reference number 402) may be referred to as a “transition point.” In some examples, a transition point may be aligned with a slot boundary, while, in some other examples, a transition point may be within a slot (e.g., such as shown in the example indicated by reference number 402).

In some examples, a TDD frame period may be limited to a maximum number of transition points, such as for a purpose of avoiding frequent switching between SBFD symbols and non-SBFD symbols. For example, a TDD frame period may be limited to a maximum of two transition points, including one transition point from non-SBFD symbols to SBFD symbols and one transition point from SBFD symbols to non-SBFD symbols. More particularly, the example TDD frame period shown in connection with reference number 404 includes two transition points, including a first transition point associated with switching from non-SBFD symbols to SBFD symbols (e.g., a transition point from downlink symbols to SBFD symbols shown within slot n+1) and a second transition point associated with switching from SBFD symbols to non-SBFD symbols (e.g., a transition point from SBFD symbols to uplink symbols shown within slot n+3).

In some examples, a network node may configure a UE to perform measurements associated with L1 procedures (sometimes referred to herein as L1 measurements), such as radio link monitoring (RLM) procedures, beam failure detection (BFD) procedures, candidate beam detection (CBD) procedures, L1-RSRP/SINR measurement procedures, or similar L1 procedures. For example, the network node may configure the UE to perform CSI-RS-based measurements for one or more L1 procedures. In such examples, the UE may perform the measurements using dedicated CSI-RS resources configured by the network node, and the UE may perform the measurements only within an active downlink BWP. When the UE is configured to operate in an SBFD mode or is configured with one or more SBFD configurations (such as one of the configurations described above in connection with reference numbers 402 and 404, among other examples), some of the configured CSI-RS resources for L1 measurements may collide (e.g., at least partially overlap, in a time domain) with a dynamically scheduled uplink transmission in an SBFD set of symbols (e.g., an uplink sub-band of an SBFD set of symbols).

During such collisions, it may be unclear whether the UE should perform CSI-RS-based L1 measurements or else transmit the dynamically scheduled uplink transmission. Put another way, in some examples, an SBFD-aware UE may be aware of a collision between the CSI-RS resources and the dynamically scheduled uplink transmission, but may otherwise be unaware of how to handle the collision (e.g., the UE may not be specified or configured with a rule for handling the collision). Accordingly, whether a particular UE receives or transmits a particular communication in a collision scenario may be left to UE implementation. This may result in a UE forgoing certain high-priority L1 measurements or transmissions, or else a UE selectively performing L1 measurements or transmissions in a transparent manner to the network node, leading to increased communication errors; high power, computing, and network resource consumption for purposes of correcting communication errors; increased latency and reduced throughput associated with communication channels between a network node and a UE; and otherwise inefficient usage of network resources.

Additionally, or alternatively, in some examples a network node may configure a UE with an SBFD transmit/reception configuration, which may indicate how a UE is to handle transmissions or receptions across SBFD and non-SBFD sets of symbols. For example, for uplink transmissions and downlink receptions across SBFD symbols and non-SBFD symbols in different slots (e.g., each transmission/reception within a slot has either all SBFD or all non-SBFD symbols), an SBFD-aware UE may be provided with a first configuration (e.g., configuration 1), in which the transmissions/receptions are restricted to SBFD symbols only or non-SBFD symbols only, or else a second configuration (e.g., configuration 2), in which the transmissions/receptions may be in SBFD symbols and non-SBFD symbols. In such examples, the SBFD-aware UE may be configured with configuration 1 or configuration 2 on an uplink/downlink BWP basis, with a configuration for the downlink BWP applying at least to PDSCH receptions within the downlink BWP, and with the configuration for the uplink BWP applying at least to PUCCH and PUSCH transmissions within the uplink BWP. In some examples, only configuration 1 may be applicable to SRS transmissions. Moreover, in some examples, configuration 1 may be a default capability, with a support of configuration 2 subject to UE capability.

In such examples, it may be unclear whether the SBFD transmit/reception configuration applies to CSI-RSs and thus whether the UE should perform CSI-RS-based measurements across SBFD slots and non-SBFD slots. Put another way, in some examples, an SBFD-aware UE may be unaware of how treat or measure CSI-RS resources extending across SBFD sets of symbols and non-SBFD sets of symbols. Accordingly, whether a particular UE measures a particular CSI-RS resource instance may be left to UE implementation. This may result in a UE forgoing certain high-priority L1 measurements, or else a UE selectively performing L1 measurements in a transparent manner to the network node, leading to increased communication errors; high power, computing, and network resource consumption for purposes of correcting communication errors; increased latency and reduced throughput associated with communication channels between a network node and a UE; and otherwise inefficient usage of network resources.

Some techniques and apparatuses described herein enable enhanced collision handling for SBFD-aware UEs, such as enhanced collision handling for a CSI-RS-based L1 measurements and dynamically scheduled uplink transmissions. Additionally, or alternatively, some techniques and apparatuses described enable enhanced CSI-RS-based measurements configurations, such as measurements of CSI-RS resources that extend across SBFD and non-SBFD sets of symbols. In some aspects, a UE may receive configuration information that indicates CSI-RS resources for performing L1 measurements that are within a downlink sub-band of an SBFD set of symbols and a dynamic indication to perform an uplink transmission in an uplink sub-band of the SBFD set of symbols. The UE may selectively perform (e.g., based at least in part on an indication receiving from a network node, a predefined rule, or certain criteria such as a previous L1 measurement satisfying a threshold, among other examples), one of the L1 measurements using the CSI-RS resources in the downlink sub-band of the SBFD set of symbols or the uplink transmission using the uplink sub-band of the SBFD set of symbols. Additionally, or alternatively, the UE may receive configuration information that indicates a CSI-RS resource configuration and an SBFD transmit/reception configuration that indicates whether the UE is to transmit or receive communications across SBFD symbols and non-SBFD symbols. The UE may perform (e.g., based at least in part on a predefined rule, an indication received from a network node, or similar information), the CSI-RS measurements using at least one of one or more non-SBFD symbols or a downlink sub-band of one or more SBFD symbols.

As a result, the UE and the network node may communicate with more transparency or exchange control information or other high-priority traffic, thus communicating with decreased communication errors, leading to reduced power, computing, and network resource consumption otherwise used for purposes of correcting communication errors; decreased latency and increased throughput associated with communication channels between the network node and the UE; and otherwise more efficient usage of network resources.

As indicated above, FIG. 4 is provided as an example. Other examples may differ from what is described with respect to FIG. 4.

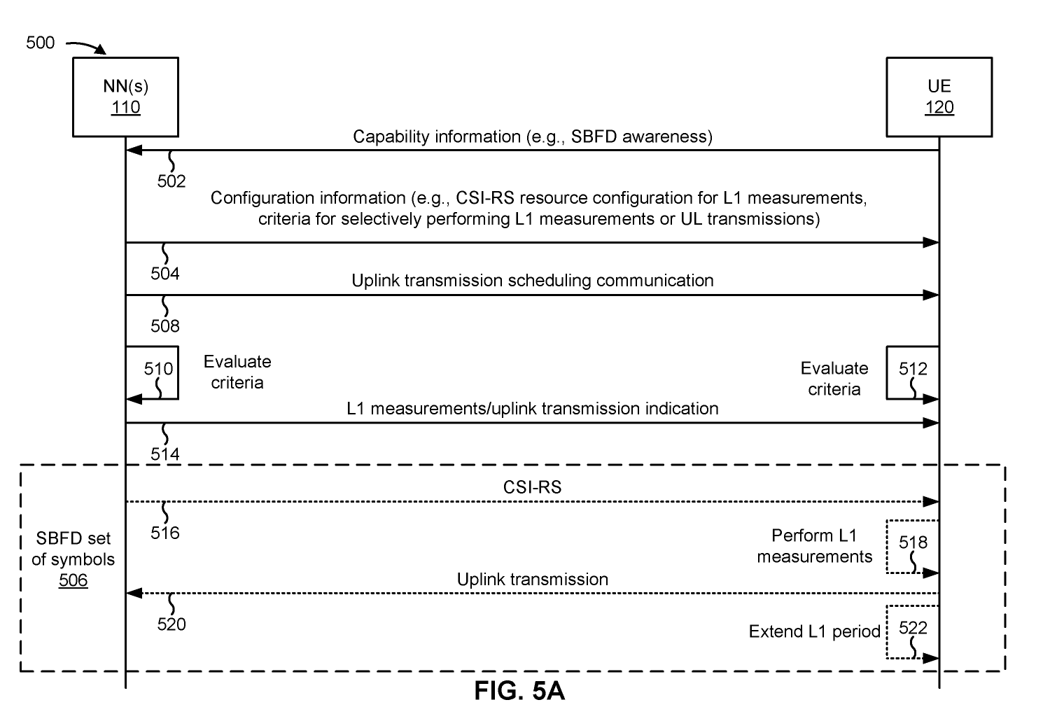

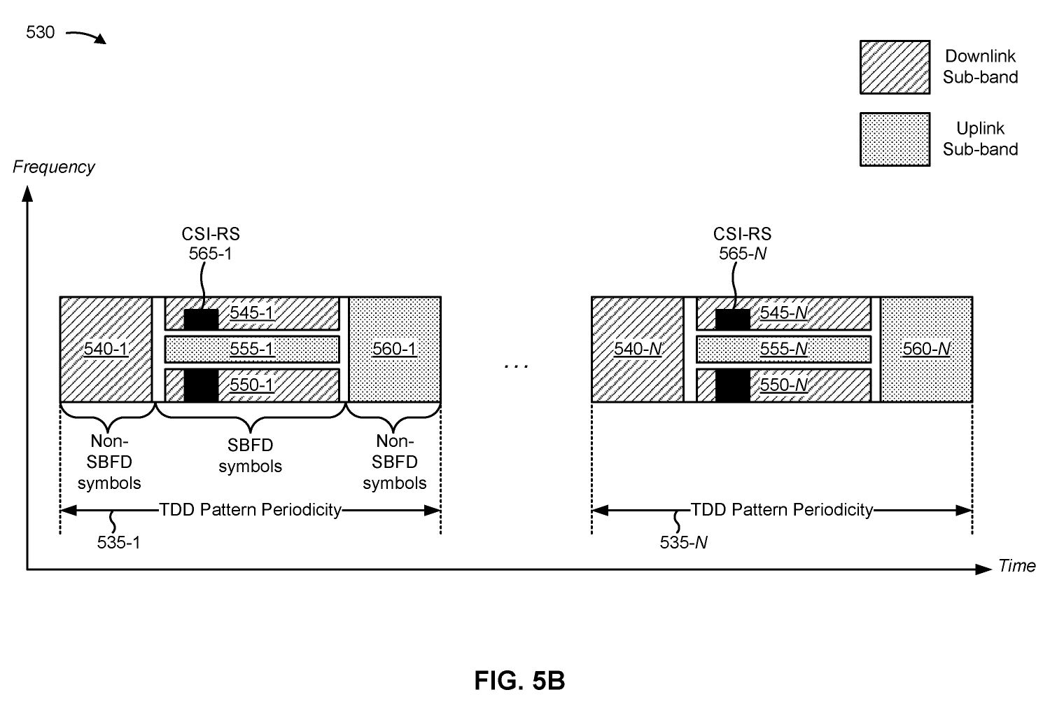

FIGS. 5A-5B are diagrams of examples associated with collision handling for SBFD sets of symbols. As shown in FIG. 5A, and by example 500, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 5A. In some aspects, the network node 110 may be capable of SBFD operation, and the UE 120 may be an SBFD-aware UE.

In some aspects, as shown by reference number 502, the UE 120 may transmit, and the network node 110 may receive, capability information. The capability information may be included in a capability report. The UE 120 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a physical sidelink control channel (PSCCH), or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter for SBFD awareness (e.g., the capability information may indicate that the UE 120 is an SBFD-aware UE). As another example, the capability information may indicate a capability or parameter for collision handling in SBFD slots. One or more operations described herein may be based on capability information. For example, the UE 120 may perform a communication in accordance with the capability information, or may receive configuration information that is in accordance with the capability information. In some aspects, the capability information may indicate UE support for performing collision handling procedures associated with overlapping CSI-RS L1 measurements and dynamically scheduled UL transmissions in SBFD sets of symbols, such as by selectively performing one of CSI-RS L1 measurements or an uplink transmissions in SBFD sets of symbols.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination. In the context of example 500, selectively performing one of the L1 measurements using the CSI-RS resources in the downlink sub-band of the SBFD set of symbols or the uplink transmission using the uplink sub-band of the SBFD set of symbols thus means determining whether to perform either the L1 measurements or the uplink transmission and then performing either the L1 measurements or the uplink determination based on that determination.

As shown by reference number 504, the network node 110 may transmit, and the UE 120 may receive, configuration information. In some aspects, the UE 120 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC-CEs or one or more DCI messages, among other examples.

In some aspects, the configuration information may include an indication of a selection of one or more configuration parameters (e.g., a selection of the one or more configuration parameters already known to the UE 120 or previously indicated by the network node or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate CSI-RS resources (e.g., CSI-RS resources 565 described in more detail below in connection with FIG. 5B) that are within a downlink sub-band of an SBFD set of symbols (such as SBFD set of symbols 506 or the SBFD symbols described in more detail below in connection with FIG. 5B). For example, the configuration information may indicate CSI-RS resources within a downlink sub-band of an SBFD set of symbols that are to be used to perform L1 measurements, such as measurements associated with one or more L1 procedure (e.g., an RLM procedure, a BFD procedure, a CBD procedure, an L1-RSRP/SINR measurement procedure, or a similar L1 procedure).

Additionally, or alternatively, in some aspects the UE 120 may selectively perform one of the L1 measurements using the CSI-RS resources in the downlink sub-band of the SBFD set of symbols or an at least partially overlapping uplink transmission using an uplink sub-band of the SBFD set of symbols (as described in more detail below in connection with reference numbers 516. 518, 520, and 522). In such aspects, the configuration information may further indicate criteria associated with the UE 120 selectively performing the one of the L1 measurements or the uplink transmission. For example, the network node 110 may configure the UE 120 with one or more L1 thresholds. In some aspects, the network node 110 may configure the UE 120 with a first threshold associated for an RLM procedure that is associated with a block error rate (BLER) of a hypothetical PDCCH that indicates an in-sync (IS) condition of the radio link (sometime referred to herein as Qᵢₙ) or a second threshold for the RLM procedure that is associated with a BLER of a hypothetical PDCCH that indicates an out-of-sync (OOS) condition of the radio link (sometimes referred to herein as Qₒᵤₜ). Additionally, or alternatively, the network node 110 may configure the UE 120 with a threshold for a BFD procedure that is associated with a BLER of a hypothetical PDCCH that indicates an OOS condition of the radio link (sometimes referred to herein as Q_{out_LR}) or a threshold for a CBD procedure that is associated with a BLER of a hypothetical PDCCH that indicates an IS condition of the radio link (sometimes referred to herein as Q_{in_LR}), among other examples. In such aspects, the UE 120 may determine whether a prior L1 measurement (e.g., an L1 measurement performed for a set of symbols that precedes the SBFD set of symbols in which the CSI-RS resources and uplink transmission collide) satisfies the one or more L1 thresholds (which is described in more detail below in connection with reference number 512), and thus may selectively perform the one of the L1 measurements or the uplink transmission based at least in part on whether the prior L1 measurement satisfies the one or more L1 thresholds.

The UE 120 may configure itself based at least in part on the configuration information. In some aspects, the UE 120 may be configured to perform one or more operations described herein based at least in part on the configuration information.

As indicated by 508, in some aspects the network node 110 may transmit, and the UE 120 may receive, an uplink transmission scheduling a communication associated with the SBFD set of symbols 506. More particularly, the network node 110 may transmit, and the UE 120 may receive, an indication that the UE 120 is to perform an uplink transmission in an uplink sub-band of the SBFD set of symbols 506. In some aspects, the communication indicated by reference number 508 may be a dynamic indication, such as a DCI (e.g., a PDCCH communication), among other examples. In that regard, the dynamically scheduled uplink transmission may collide (e.g., at least partially overlap) with the semi-statically configured CSI-RS resources for performing L1 measurements.

In some aspects, and as indicated by reference numbers 510 and 512, the network node 110 or the UE 120, respectively, may evaluate certain criteria to determine which one of the L1 measurements of the uplink transmission is to be performed by the UE 120. Put another way, in some aspects, selectively performing the one of the L1 measurements or the uplink transmission may be based at least in part on certain criteria, such as whether a prior L1 measurement result (e.g., an L1 measurement result that is associated with a set of symbols that precedes the SBFD set of symbols 506) satisfies a threshold, among other examples.

More particularly, in aspects in which the network node 110 evaluates the criteria (as indicated by reference number 510), the UE 120 may transmit, and the network node 110 may receive, L1 measurement results associated with a set of symbols that precedes the SBFD set of symbols 506 (not shown in FIG. 5A). In such aspects, the network node 110 may compare the prior L1 measurement results to a threshold, such as one or more of the thresholds described above in connection with the configuration information (e.g., Qᵢₙ, Qₒᵤₜ, Q_{out_LR}, or Q_{in_LR}, among other examples). In some other aspects, such as aspects in which the UE 120 evaluates the criteria (as indicated by reference number 512), the UE 120 may compare the prior L1 measurement results to a threshold, such as one or more thresholds indicated by the configuration information (e.g., Qᵢₙ, Qₒᵤₜ, Q_{out_LR}, or Q_{in_LR}, among other examples).

In such aspects, the network node 110 or the UE 120 may determine that the uplink transmission is to be performed in the SBFD set of symbols 506 (and thus the L1 measurements should not be performed in the SBFD set of symbols 506) if the evaluation indicates low mobility or good cell conditions, among other examples. On the other hand, the network node 110 or the UE 120 may determine that the L1 measurements are to be performed in the SBFD set of symbols 506 (and thus the uplink transmission should not be performed in the SBFD set of symbols 506) if the evaluation indicates high mobility or poor cell conditions, among other examples.

In some aspects, such as aspects in which the network node 110 performs the evaluation, the network node 110 may transmit, and the UE 120 may receive, an L1 measurements/uplink transmission indication, as indicated by reference number 514. The L1 measurements/uplink transmission indication may indicate whether the UE 120 is to perform the L1 measurements or the uplink transmission in the SBFD set of symbols 506. For example, and in a similar manner as described above, in some aspects the network node 110 may determine, based on the past measurement results reported by the UE 120 (among other examples), low mobility or good cell conditions, and thus the L1 measurements/uplink transmission indication may indicate that the UE 120 is to transmit the uplink transmission in the SBFD set of symbols 506 (and thus forgo the L1 measurements in the SBFD set of symbols 506). On the other hand, the network node 110 may determine, based on the past measurement results reported by the UE 120 (among other examples), high mobility or poor cell conditions, and thus the L1 measurements/uplink transmission indication may indicate that the UE 120 is to perform L1 measurements in the SBFD set of symbols 506 (and thus forgo the uplink transmission in the SBFD set of symbols 506).

In some other aspects, selectively performing the one of the L1 measurements or the uplink transmission is based at least in part on a predefined rule, such as a rule specified by a relevant wireless communication standard (e.g., a standard promulgated by the 3GPP) that is preconfigured, hard-coded, or otherwise predefined at the UE 120. For example, in some aspects the predefined rule may indicate that when CSI-RS resources for L1 measurements collide with a dynamically scheduled uplink transmission, the UE 120 is to follow the dynamic configuration for the uplink transmission and thus is to drop the CSI-RS-based measurements for L1 procedures in the SBFD set of symbols 506. In some other aspects, the predefined rule may indicate that, when CSI-RS resources for L1 measurements collide with a dynamically scheduled uplink transmission, the UE 120 is to ignore the dynamic configuration for the uplink transmission and instead is to proceed with the CSI-RS based measurements in the SBFD set of symbols.

In some aspects, such as in aspects in which the UE 120 is to proceed with the CSI-RS based measurements in the SBFD set of symbols 506 (e.g., via a predefined rule or otherwise), a predefined rule may indicate one or more uplink transmission types that are prohibited from overlapping with the CSI-RS resources. Put another way, in aspects in which it is determined that the UE 120 is to proceed with the CSI-RS-based measurements during collisions with a scheduled uplink transmission in the SBFD set of symbols 506, a predefined rule may specify scheduling restrictions on data associated with the uplink transmission. For example, the one or more uplink transmission types that are prohibited from overlapping with the CSI-RS resources may be associated with at least one of a PUCCH-based transmission, a PUSCH-based transmission, or an SRS transmission, among other examples. Put another way, in some aspects, a UE 120 may not be expected to receive a DCI or higher-layer configuration scheduling the UE 120 to transmit PUCCH, PUSCH or SRS on the CSI-RS symbols to be measured for RLM, BFD, or CBD. In some other aspects, the UE 120 may not be expected to transmit dynamically scheduled PUCCH, PUSCH or SRS on the SBFD set of symbols 506 where CSI-RS symbols are configured to be measured for RLM, BFD, or CBD, among other examples.

As indicated by reference numbers 516, 518, and 520, based at least in part on the configuration information, criteria, indications, predefined rules, or similar information described above, the UE 120 may selectively perform one of the L1 measurements using the CSI-RS resources in the downlink sub-band of the SBFD set of symbols 506, or the uplink transmission using the uplink sub-band of the SBFD set of symbols 506. More particularly, in aspects in which the UE 120 performs the L1 measurements, the network node 110 may transmit, and the UE 120 may receive, one or more CSI-RSs using the configured CSI-RS resources in the downlink sub-band of the SBFD set of symbols 506, as indicated by the reference number 516, and the UE 120 may perform the L1 measurements using the CSI-RS resources in the downlink sub-band of the SBFD set of symbols 506, as indicated by reference number 518. Moreover, in aspects in which the UE 120 performs the uplink transmission, the UE 120 may transmit, and the network node 110 may receive, the uplink transmission using an uplink sub-band (e.g., the uplink sub-band 555 described in more detail below in connection with FIG. 5B) of the SBFD set of symbols 506, as indicated by reference number 520.

As indicated by reference number 522, in some aspects, such as aspects in which the UE 120 selectively performs the uplink transmission (as described above in connection with reference number 520), the UE 120 may extend an L1 period based at least in part on performing the uplink transmission. For example, the UE 120 may extend one or more of an RLM OOS evaluation period, an RLM IS evaluation period, a BFD evaluation period, a CBD evaluation period, an L1-RSRP measurement period, an L1-SINR measurement period, or a similar L1 period. Additionally, or alternatively, in some aspects, the UE 120 may extend the L1 period by a multiple of a CSI-RS periodicity (sometimes referred to herein as M_{CSI-RS-deprioritized}), with the multiple being the quantity of occasions within an L1 period in which a dynamically scheduled uplink transmission is prioritized over a CSI-RS reception at the UE 120.

More particularly, in some aspects an L1 period may be associated with a RLM OOS evaluation period (sometimes referred to as T_{Evaluate_out_CSI-RS}) that is based at least in part on a parameter referred to herein as Mₒᵤₜ. For example, in aspects in which the UE 120 is not associated with discontinuous reception (DRX), T_{Evaluate_out_CSI-RS}, in milliseconds (ms), may be equal to Max(200, Ceil(Mₒᵤₜ×P)×T_{CSI-RS}), where T_{CSI-RS} is the periodicity of the CSI-RS resource configured for RLM and Mₒᵤₜ and P are parameters defined by Technical Specification (TS) 38.133 as promulgated by the 3GPP. Additionally, or alternatively, in aspects in which the UE 120 is associated with a DRX cycle length (T_{DRX}) of ≤ 320 ms, T_{Evaluate_out_CSI-RS} may be equal to Max(200, Ceil(1.5×Mₒᵤₜ×P)× Max(T_{DRX}, T_{CSI-RS})). Moreover, in aspects in which the UE 120 is associated with a DRX cycle length of > 320 ms, T_{Evaluate_out_CSI-RS} may be equal to Ceil(Mₒᵤₜ×P) × T_{DRX}. In such aspects, the UE 120 may adjust the Mₒᵤₜ parameter (with Mₒᵤₜ’ being used to denote the adjusted parameter) based at least in part on the multiple of the CSI-RS periodicity, such as according to the following equation: Mₒᵤₜ’ = Mₒᵤₜ + M_{CSI-RS-deprioritized}.

In some other aspects, an L1 period may be associated with a RLM IS evaluation period (sometimes referred to as T_{Evaluate_In_CSI-RS}) that is based at least in part on a parameter referred to herein as Mᵢₙ. For example, in aspects in which the UE 120 is not associated with DRX, T_{Evaluate_In_CSI-RS}, in ms, may be equal to Max(100, Ceil(Mᵢₙ×P)×T_{CSI-RS}), where Mᵢₙ is a parameter defined by TS 38.133. Additionally, or alternatively, in aspects in which the UE 120 is associated with a DRX cycle length of ≤ 320 ms, T_{Evaluate_In_CSI-RS} may be equal to Max(100, Ceil(1.5×Mᵢₙ×P)× Max(T_{DRX}, T_{CSI-RS})). Moreover, in aspects in which the UE 120 is associated with a DRX cycle length of > 320 ms, T_{Evaluate_in_CSI-RS} may be equal to Ceil(Mᵢₙ×P) × T_{DRX}. In such aspects, the UE 120 may adjust the Mᵢₙ parameter (with Mᵢₙ’ being used to denote the adjusted parameter) based at least in part on the multiple of the CSI-RS periodicity, such as according to the following equation: Mᵢₙ’ = Mᵢₙ + M_{CSI-RS-deprioritized}.

In some other aspects, an L1 period may be associated with a BFD evaluation period (sometimes referred to as T_{Evaluate_BFD_CSI-RS}) that is based at least in part on a parameter referred to herein as M_{BFD}. For example, in aspects in which the UE 120 is not associated with DRX, T_{Evaluate_BFD_CSI-RS}, in ms, may be equal to Max(50, Ceil(M_{BFD}×P×P_{BFD})×T_{CSI-RS}), where M_{BFD} and P_{BFD} are parameters defined by TS 38.133. Additionally, or alternatively, in aspects in which the UE 120 is associated with a DRX cycle length of ≤ 320 ms, T_{Evaluate_BFD_CSI-RS} may be equal to Max(50, Ceil(1.5×M_{BFD}×P×P_{BFD})× Max(T_{DRX}, T_{CSI-RS})). Moreover, in aspects in which the UE 120 is associated with a DRX cycle length of > 320 ms, T_{Evaluate_BFD_CSI-RS} may be equal to Ceil(M_{BFD}×P×P_{BFD}) × T_{DRX}. In such aspects, the UE 120 may adjust the M_{BFD} parameter (with M_{BFD}’ being used to denote the adjusted parameter) based at least in part on the multiple of the CSI-RS periodicity, such as according to the following equation: M_{BFD}’ = M_{BFD} + M_{CSI-RS-deprioritized}.

In some other aspects, an L1 period may be associated with a CBD evaluation period (sometimes referred to as T_{Evaluate_CBD_CSI-RS}) that is based at least in part on a parameter referred to herein as M_{CBD}. For example, in aspects in which the UE 120 is not associated with DRX or a DRX cycle length of ≤ 320 ms, T_{Evaluate_CBD_CSI-RS}, in ms, may be equal to Max(25, Ceil(M_{CBD}×P×P_{CBD})×T_{CSI-RS}), where M_{CBD} and P_{CBD} are parameters defined by TS 38.133. Additionally, or alternatively, in aspects in which the UE 120 is associated with a DRX cycle length of > 320 ms, T_{Evaluate_CBD_CSI-RS} may be equal to Ceil(M_{BFD}×P×P_{CBD}) × T_{DRX}. In such aspects, the UE 120 may adjust the M_{CBD} parameter (with M_{CBD}’ being used to denote the adjusted parameter) based at least in part on the multiple of the CSI-RS periodicity, such as according to the following equation: M_{CBD}’ = M_{CBD} + M_{CSI-RS-deprioritized}.

FIG. 5B shows an example 530 of a TDD pattern associated with SBFD symbols and non-SBFD symbols. As shown by example 530, a TDD pattern may be associated with a repeating pattern of symbols having a certain TDD pattern periodicity 535 (shown as a first instance of the TDD patten periodicity 535-1 through an N th instance of the TDD pattern periodicity 535-N in FIG. 5B). More particularly, each instance of the repeating pattern of symbols may include a first set of non-SBFD symbols that includes only downlink symbols 540; a set of SBFD symbols that includes a first downlink sub-band 545, a second downlink sub-band 550, and an uplink sub-band 555; and a second set of non-SBFD symbols that includes only uplink symbols 560. In some other aspects, the first downlink sub-band 545 and the second downlink sub-band 550 may collectively be referred to a single, non-continuous downlink sub-band.

In such examples, a UE 120 configured with the TDD pattern shown in FIG. 5B may have to perform collision handling techniques in the SBFD symbols, among other examples. For example, the network node 110 may semi-statically configure (e.g., via the configuration information described above in connection with reference number 504) the UE 120 with CSI-RS resources 565 in one or both of the downlink sub-bands 545, 550 of the SBFD symbols (shown as a first instance of the CSI-RS resources 565-1 in connection with the first instance of the TDD patten periodicity 535- 1 and as an N th instance of the CSI-RS resources 565-N in connection with the N th instance of the TDD patten periodicity 535-N). Additionally, or alternatively, the network node 110 may dynamically schedule the UE 120 with resources for performing an unlink transmission in the uplink sub-band 555 of the SBFD symbols that collides with an instance of the CSI-RS resources 565 (e.g., that at least partially overlaps with the instance of the CSI-RS resources 565). In such aspects, the UE 120 may selectively measure a CSI-RS associated with the CSI-RS resources 565 using the downlink sub-bands 545, 550, or else the UE 120 may perform the uplink transmission using the uplink sub-band 555, in a substantially similar manner as described above in connection with FIG. 5A.

As indicated above, FIGS. 5A-5B are provided as examples. Other examples may differ from what is described with respect to FIGS. 5A-5B.

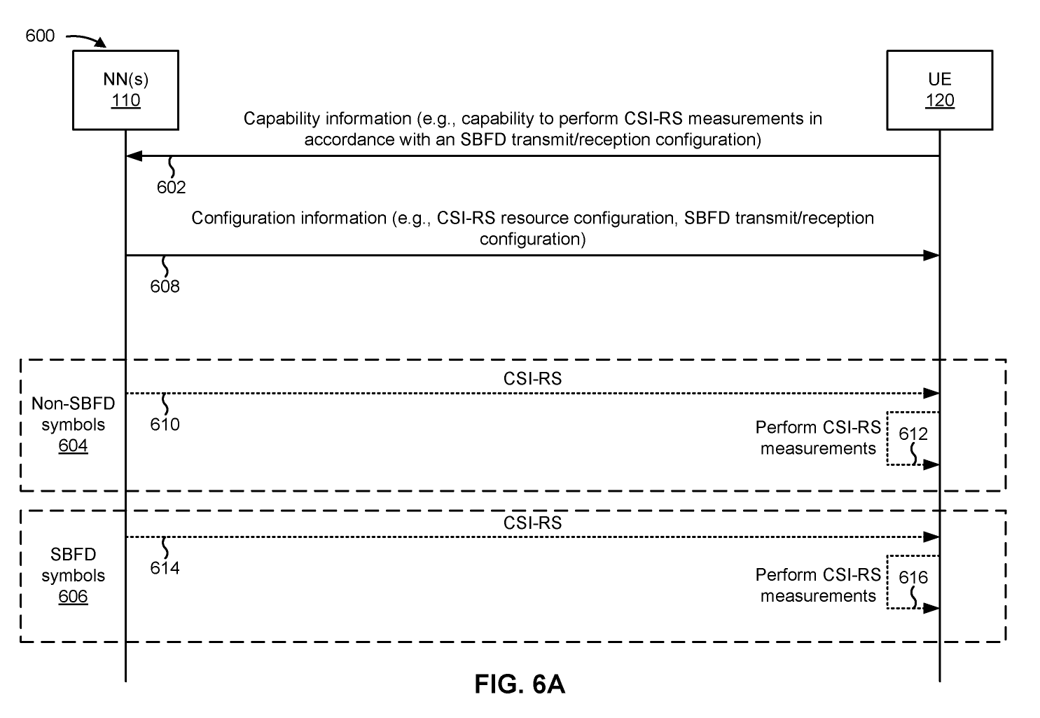

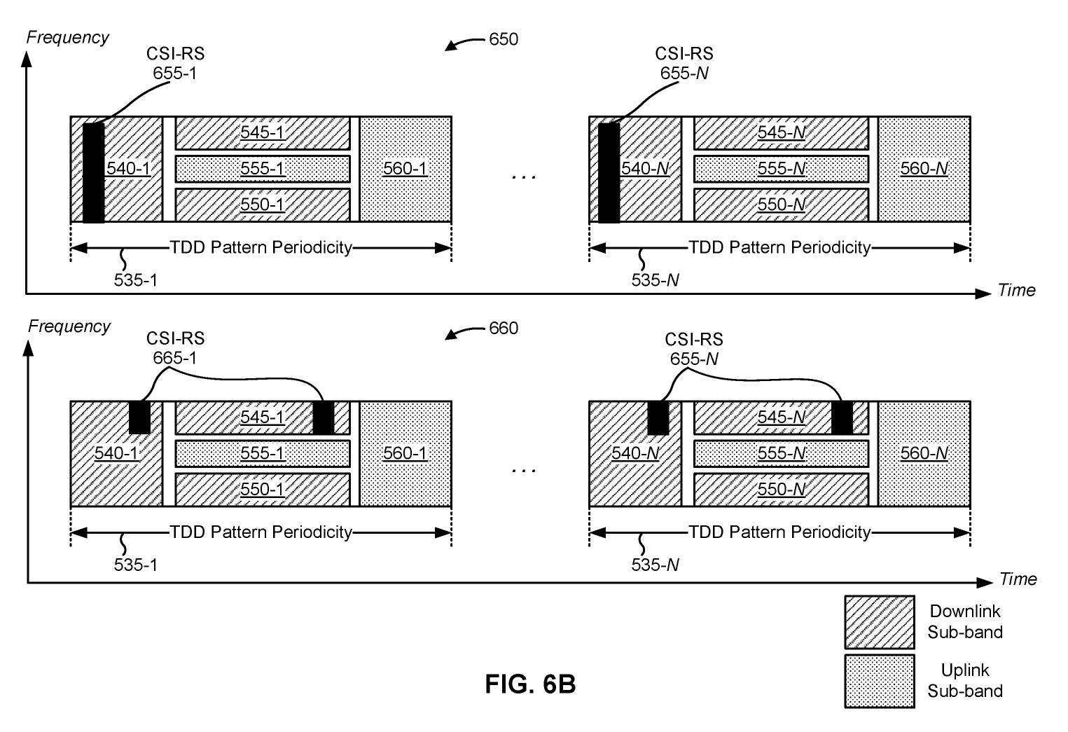

FIGS. 6A-6B are diagrams of examples associated with CSI-RS measurements across SBFD symbols and non-SBFD symbols. As shown in FIG. 6A, and by example 600, a network node 110 (e.g., a base station, a CU, a DU, or an RU) may communicate with a UE 120. In some aspects, the network node 110 and the UE 120 may correspond to the network node 110 and the UE 120, respectively, described above in connection with FIG. 5A. In that regard, the network node 110 and the UE 120 may be part of a wireless network (e.g., the wireless communication network 100). The UE 120 and the network node 110 may have established a wireless connection prior to operations shown in FIG. 6A. In some aspects, and in a similar manner as described above in connection with FIG. 5A, the network node 110 may be capable of SBFD operation, and the UE 120 may be an SBFD-aware UE.

In some aspects, as shown by reference number 602, the UE 120 may transmit capability information. The capability information may be included in a capability report or may be similar to the configuration information described above in connection with reference number 502. In that regard, the capability information may indicate a capability or parameter for SBFD awareness (e.g., the capability information may indicate that the UE 120 is an SBFD-aware UE), in a similar manner as described above in connection with FIG. 5A. Additionally, or alternatively, the capability information may indicate a capability or parameter for performing CSI-RS measurements across SBFD symbols and non-SBFD symbols. For example, in some aspects the capability information may indicate UE support for performing CSI-RS measurements across non-SBFD symbols (e.g., non-SBFD symbols 604) and SBFD symbols (e.g., SBFD symbols 606), while, in some other aspects, the capability information may indicate that the UE 120 is capable of performing CSI-RS measurements in only one type of symbol (e.g., either only in the non-SBFD symbols 604 or only in the SBFD symbols 606), among other examples.

In some aspects, and as described in more detail below in connection with reference number 608, the UE 120 may be configured with an SBFD transmit/reception indication that indicates one of configuration 1 (e.g., UE transmissions/receptions are restricted to SBFD symbols only or non-SBFD symbols only) or configuration 2 (e.g., UE transmissions/receptions may be across SBFD symbols and non-SBFD symbols). In such aspects, the capability information may indicate UE support for performing CSI-RS measurements in accordance with the SBFD transmit/reception configuration. More particularly, the capability information may indicate which configurations the UE 120 supports (e.g., configuration 1, configuration 2, or both configuration 1 and 2) for CSI-RS measurements, such as for measurements of CSI-RS resources configured for L1-RSRP procedures, L1-SINR procedures, RLM procedures, BFD procedures, CBD procedures, or similar procedures.

One or more operations described herein may be based on capability information. For example, the UE 120 may perform a communication in accordance with the capability information, or may receive configuration information that is in accordance with the capability information.

As shown by reference number 608, the network node 110 may transmit, and the UE 120 may receive, configuration information, which may be substantially similar to the configuration information described above in connection with reference number 504. In this aspect, the configuration information may indicate a CSI-RS resource configuration that indicates resources (e.g., CSI-RS resources 655, 665 described in more detail below in connection with FIG. 6B) for performing CSI-RS measurements. For example, the configuration information may indicate CSI-RS resources within non-SBFD symbols (e.g., downlink symbols) or a downlink sub-band of SBFD symbols that are to be used to perform CSI-RS measurements, such as measurements associated with one or more L1 procedure (e.g., an RLM procedure, a BFD procedure, a CBD procedure, an L1-RSRP/SINR measurement period, or a similar L1 procedure) as described above in connection with FIGS. 5A-5B or substantially similar L1 or layer 3 (L3) CSI-RS-based RRM measurements, among other examples.

Additionally, or alternatively, the configuration information may include an SBFD transmit/reception configuration that indicates whether the UE is to transmit or receive communications across SBFD symbols and non-SBFD symbols. For example, the SBFD transmit/reception configuration may be associated with configuration 1 described above in connection with FIG. 4, in which UE transmissions/receptions are restricted to SBFD symbols only or non-SBFD symbols only. In some other aspects, the SBFD transmit/reception configuration may be associated with configuration 2 described above in connection with FIG. 4, in which UE transmissions/receptions may be across SBFD symbols and non-SBFD symbols.

Additionally, or alternatively, in aspects in which the UE 120 is configured with an SBFD transmit/reception configuration associated with configuration 1 (e.g., a configuration indicating that the UE 120 is to transmit or receive communications in only SBFD symbols or only non-SBFD symbols), the configuration information may indicate which type of symbols the UE 120 is to use for CSI-RS measurements, among other examples. For example, in some aspects the UE 120 may be configured with configuration 1 and the configuration information may further indicate that the UE 120 is to perform CSI-RS measurements only in non-SBFD symbols, while, in some other aspects, the UE 120 may be provided with configuration 1 and the configuration information may further indicate that the UE 120 is to perform CSI-RS measurements only in SBFD symbols. In this regard, in some aspects only configuration 1 may be applicable to CSI-RS and only a single valid symbol type (e.g., one of SBFD or non-SBFD) may be used for a CSI-RS resource. Put another way, in some aspects, the UE 120 may not be expected to have separate CSI-RS-based measurement procedures (e.g., BFD procedures, RRM procedures, CBD procedures, L1-RSRP procedures, L1-SINR procedures, or similar procedures) for SBFD and non-SBFD symbols. In some aspects, the type of symbols (sometimes referred to herein as a valid symbols type, which may be one of “SBFD” or “non-SBFD”) to be used for the CSI-RS measurements may be semi-statically indicated to the UE 120 by RRC configuration, such as via an RRC parameter associated with a CSI-RS resource set configuration (e.g., an RRC parameter under the CSI-RS resource/set level), an RRC parameter associated with a CSI report configuration (e.g., an RRC parameter under the CSI-Report (L1-SINR/L1-RSRP) level), or an RRC parameter associated with a CSI measurement configuration (e.g., an RRC parameter under the MeasurementConfig level).

The UE 120 may configure itself based at least in part on the configuration information. In some aspects, the UE 120 may be configured to perform one or more operations described herein based at least in part on the configuration information.

As indicated by reference numbers 610, 612, 614, and 616, the UE 120 may perform, based at least in part on the configuration information described above in connection with reference number 608, CSI-RS measurements using the non-SBFD symbols 604 or a downlink sub-band of the SBFD symbols 606. For example, in aspects in which the SBFD transmit/reception configuration indicates that the UE 120 is to perform CSI-RS measurements in only non-SBFD symbols, the network node 110 may transmit, and the UE 120 may receive, a CSI-RS in the non-SBFD symbols 604, as indicated by reference number 610, and the UE 120 may perform CSI-RS measurements using the CSI-RS received in the non-SBFD symbols 604, as indicated by reference number 612. Similarly, in aspects in which the SBFD transmit/reception configuration indicates that the UE 120 is to perform CSI-RS measurements in only SBFD symbols, the network node 110 may transmit, and the UE 120 may receive, a CSI-RS in a downlink sub-band of the SBFD symbols 606, as indicated by reference number 614, and the UE 120 may perform CSI-RS measurements using the CSI-RS received in the downlink sub-band of the SBFD symbols 606, as indicated by reference number 616. Moreover, in aspects in which the SBFD transmit/reception configuration indicates that the UE 120 is to perform CSI-RS measurements across non-SBFD symbols and SBFD symbols, the network node 110 may transmit, and the UE 120 may receive, a CSI-RS in both the non-SBFD symbols 604 and the SBFD symbols 606, as indicated by reference numbers 610 and 614, and the UE 120 may perform CSI-RS measurements using the CSI-RSs received in both the non-SBFD symbols 604 and the SBFD symbols 606, as indicated by reference numbers 612 and 616. For example, in aspects in which the UE 120 uses the CSI-RS resources for RRM measurements, the RRM procedures may be carried across both symbol types assuming inter-UE cross-link interference (CLI) is negligible, among other examples.

In some other aspects, the UE 120 may perform the operations described above in connection with example 310 and reference numbers 612, 614, and 616 agnostic to the SBFD transmit/reception configuration. For example, in some aspects, the SBFD transmit/reception configuration may not apply to CSI-RS measurements based at least in part on a predefined rule, such as a rule specified by a relevant wireless communication standard (e.g., a standard promulgated by the 3GPP) that is preconfigured, hard-coded, or otherwise predefined at the UE 120. Put another way, in some aspects, when an SBFD-aware UE is provided with configuration 1 or 2 on a per uplink/downlink BWP basis, the UE 120 may determine that these configurations are not applicable to CSI-RS resources for CSI-RS measurements (e.g., L1-RSRP/SINR measurement and RLM/BFD/CBD measurement). Moreover, in such aspects, the CSI-RS may be transmitted in only one of the non-SBFD symbols 604 or the SBFD symbols 606 based at least in part on the predefined rule. For example, in some aspects, the CSI-RS resources may occur only in the non-SBFD symbols 604 based at least in part on the predefined rule (e.g., the predefined rule may specify that the network node 110 should only configure CSI-RS resources in non-SBFD symbols (e.g., downlink symbols)), while, in some other aspects, the CSI-RS resources may occur in both the non-SBFD symbols 604 and the downlink sub-band of the SBFD symbols 606 based at least in part on the predefined rule (e.g., the predefined rule may specify that the network node 110 may configure CSI-RS resources across non-SBFD symbols (e.g., downlink symbols) and downlink sub-bands of SBFD symbols). Additional aspects regarding configuring CSI-RS resources only in non-SBFD symbols 604 or across non-SBFD symbols 604 and a downlink sub-band of SBFD symbols 606 are described in more detail below in connection with FIG. 6B.

More particularly, FIG. 6B shows examples 650, 660 associated with configuring CSI-RS resources in non-SBFD symbols and across non-SBFD symbols and downlink sub-bands of SBFD symbols, respectively, of the TDD patterns described above in connection with FIG. 5B. First, as shown in example 650, in some aspects the network node 110 may configure CSI-RS resources 655 such that that the CSI-RS resources 655 only occur only in the downlink symbols 540. In this way, example 650 may be associated with aspects in which an SBFD-aware UE is provided with SBFD transmit/reception configuration 1 or 2 on a per uplink/downlink BWP basis, but such configurations are not applicable to CSI-RS measurements and instead the network node 110 is expected to only configure the CSI-RS resources in the downlink symbols 540 (e.g., only in the non-SBFD symbols 604).

On the other hand, as shown in example 660, in some aspects the network node 110 may configure CSI-RS resources 665 such that that the CSI-RS resources 665 occur across the downlink symbols 540 and one or more downlink sub-bands of the SBFD symbols (such as the first downlink sub-band 545 of the SBFD symbols, as shown in FIG. 6B). In this way, example 660 may be associated with aspects in which an SBFD-aware UE is provided with SBFD transmit/reception configuration 1 or 2 on a per uplink/downlink BWP basis, but such configurations are not applicable to CSI-RS measurements and instead the network node 110 is expected to configure the CSI-RS resources across the downlink symbols 540 (e.g., the non-SBFD symbols 604) and the downlink sub-band 545 of the SBFD symbols (e.g., the SBFD symbols 606).

Based at least in part on the UE 120 and the network node 110 performing the collision handling techniques described above in connection with FIGS. 5A-5B or the CSI-RS measurement configuration techniques described above in connection with FIGS. 6A-6B, the UE 120 or the network node 110 may conserve computing, power, network, or communication resources that may have otherwise been consumed traditional SBFD-based communications. For example, based at least in part on the UE 120 and the network node 110 performing the collision handling techniques described above in connection with FIGS. 5A-5B or the CSI-RS measurement configuration techniques described above in connection with FIGS. 6A-6B, the UE 120 and the network node 110 may communicate with improved communication channels or a reduced error rate, which may conserve computing, power, network, or communication resources that may have otherwise been consumed to detect or correct communication errors.

As indicated above, FIGS. 6A-6B are provided as examples. Other examples may differ from what is described with respect to FIGS. 6A-6B.

FIG. 7 is a diagram illustrating an example process 700 performed, for example, at a UE or an apparatus of a UE. Example process 700 is an example where the apparatus or the UE (e.g., UE 120) performs operations associated with collision handling for SBFD sets of symbols.

As shown in FIG. 7, in some aspects, process 700 may include receiving configuration information that CSI-RS resources that are within a downlink sub-band of an SBFD set of symbols, wherein the CSI-RS resources are associated with L1 measurements (block 710). For example, the UE (e.g., using reception component 1102 or communication manager 1106, depicted in FIG. 11) may receive configuration information that indicates CSI-RS resources that are within a downlink sub-band of an SBFD set of symbols, wherein the CSI-RS resources are associated with L1 measurements, as described above.

As further shown in FIG. 7, in some aspects, process 700 may include receiving a first indication that the UE is to perform an uplink transmission in an uplink sub-band of the SBFD set of symbols (block 720). For example, the UE (e.g., using reception component 1102 or communication manager 1106, depicted in FIG. 11) may receive a first indication that the UE is to perform an uplink transmission in an uplink sub-band of the SBFD set of symbols, as described above.

As further shown in FIG. 7, in some aspects, process 700 may include selectively performing, based at least in part on the configuration information and the first indication, one of: the L1 measurements using the CSI-RS resources in the downlink sub-band of the SBFD set of symbols, or the uplink transmission using the uplink sub-band of the SBFD set of symbols (block 730). For example, the UE (e.g., using communication manager 1106, depicted in FIG. 11) may selectively perform, based at least in part on the configuration information and the first indication, one of: the L1 measurements using the CSI-RS resources in the downlink sub-band of the SBFD set of symbols, or the uplink transmission using the uplink sub-band of the SBFD set of symbols, as described above.

Process 700 may include additional aspects, such as any single aspect or any combination of aspects described below or in connection with one or more other processes described elsewhere herein.

In a first aspect, process 700 includes receiving a second indication that indicates whether the UE is to perform the L1 measurements or the uplink transmission, wherein selectively performing the one of the L1 measurements or the uplink transmission is based at least in part on the second indication.

In a second aspect, alone or in combination with the first aspect, process 700 includes transmitting L1 measurement results associated with a set of symbols that precedes the SBFD set of symbols, wherein the second indication is based at least in part on the L1 measurement results associated with the set of symbols.

In a third aspect, alone or in combination with one or more of the first and second aspects, the configuration information further indicates criteria associated with the UE selectively performing the one of the L1 measurements or the uplink transmission, and selectively performing the one of the L1 measurements or the uplink transmission is based at least in part on the criteria.

In a fourth aspect, alone or in combination with one or more of the first through third aspects, the criteria are associated with an L1 measurement result, that is associated with a set of symbols that precedes the SBFD set of symbols, satisfying a threshold.

In a fifth aspect, alone or in combination with one or more of the first through fourth aspects, selectively performing the one of the L1 measurements or the uplink transmission is based at least in part on a predefined rule.

In a sixth aspect, alone or in combination with one or more of the first through fifth aspects, the predefined rule indicates that the UE is to selectively perform the uplink transmission.

In a seventh aspect, alone or in combination with one or more of the first through sixth aspects, selectively performing the one of the L1 measurements or the uplink transmission includes performing the uplink transmission, and the process 700 further comprises extending an L1 period based at least in part on performing the uplink transmission.

In an eighth aspect, alone or in combination with one or more of the first through seventh aspects, extending the L1 period includes extending the L1 period by a multiple of a CSI-RS periodicity.

In a ninth aspect, alone or in combination with one or more of the first through eighth aspects, selectively performing the one of the L1 measurements or the uplink transmission includes performing the L1 measurements based at least in part on a predefined rule, and the predefined rule indicates one or more uplink transmission types that are prohibited from overlapping with the CSI-RS resources.

In a tenth aspect, alone or in combination with one or more of the first through ninth aspects, the one or more uplink transmission types that are prohibited from overlapping with the CSI-RS resources are associated with at least one of a physical-uplink-control-channel-based transmission, a physical-uplink-shared-channel-based transmission, or a sounding reference signal transmission.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a UE or an apparatus of a UE. Example process 800 is an example where the apparatus or the UE (e.g., UE 120) performs operations associated with CSI-RS measurements across SBFD symbols and non-SBFD symbols.

As shown in FIG. 8, in some aspects, process 800 may include receiving configuration information that indicates a CSI-RS resource configuration that indicates resources for performing CSI-RS measurements, and an SBFD transmit/reception configuration that indicates whether the UE is to transmit or receive communications across SBFD symbols and non-SBFD symbols (block 810). For example, the UE (e.g., using reception component 1102 or communication manager 1106, depicted in FIG. 11) may receive configuration information that indicates a CSI-RS resource configuration that indicates resources for performing CSI-RS measurements, and an SBFD transmit/reception configuration that indicates whether the UE is to transmit or receive communications across SBFD symbols and non-SBFD symbols, as described above.

As further shown in FIG. 8, in some aspects, process 800 may include performing, based at least in part on the configuration information, the CSI-RS measurements using at least one of one or more non-SBFD symbols, or a downlink sub-band of one or more SBFD symbols (block 820). For example, the UE (e.g., using communication manager 1106, depicted in FIG. 11) may perform, based at least in part on the configuration information, the CSI-RS measurements using at least one of one or more non-SBFD symbols, or a downlink sub-band of one or more SBFD symbols, as described above.

Process 800 may include additional aspects, such as any single aspect or any combination of aspects described below or in connection with one or more other processes described elsewhere herein.

In a first aspect, the SBFD transmit/reception configuration does not apply to the CSI-RS measurements based at least in part on a predefined rule.

In a second aspect, alone or in combination with the first aspect, the CSI-RS resources occur only in one or more non-SBFD symbols based at least in part on the predefined rule.

In a third aspect, alone or in combination with one or more of the first and second aspects, the CSI-RS resources occur in both the one or more non-SBFD symbols, and the downlink sub-band of the one or more SBFD symbols, based at least in part on the predefined rule.

In a fourth aspect, alone or in combination with one or more of the first through third aspects, the SBFD transmit/reception configuration indicates that the UE is to transmit or receive communications across SBFD symbols and non-SBFD symbols, and the process 800 further comprises performing the CSI-RS measurements using both the one or more non-SBFD symbols, and the downlink sub-band of the one or more SBFD symbols, based at least in part on the SBFD transmit/reception configuration indicating that the UE is to transmit or receive communications across SBFD symbols and non-SBFD symbols.

In a fifth aspect, alone or in combination with one or more of the first through fourth aspects, the SBFD transmit/reception configuration indicates that the UE is not to transmit or receive communications across SBFD symbols and non-SBFD symbols, and the process 800 further comprises performing the CSI-RS measurements using one of the one or more non-SBFD symbols, or the downlink sub-band of the one or more SBFD symbols, based at least in part on the SBFD transmit/reception configuration indicating that the UE is not to transmit or receive communications across SBFD symbols and non-SBFD symbols.

In a sixth aspect, alone or in combination with one or more of the first through fifth aspects, the configuration information further indicates the one of the one or more non-SBFD symbols, or the downlink sub-band of the one or more SBFD symbols, associated with the CSI-RS measurements.

In a seventh aspect, alone or in combination with one or more of the first through sixth aspects, the configuration information indicates the one of the one or more non-SBFD symbols, or the downlink sub-band of the one or more SBFD symbols, associated with the CSI-RS measurements via at least one of a first RRC parameter associated with a CSI-RS resource set configuration, a second RRC parameter associated with a CSI report configuration, or a third RRC parameter associated with a CSI measurement configuration.

In an eighth aspect, alone or in combination with one or more of the first through seventh aspects, process 800 includes transmitting capability information indicating UE support for performing CSI-RS measurements in accordance with the SBFD transmit/reception configuration, wherein the configuration information is based at least in part on the capability information.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node. Example process 900 is an example where the apparatus or the network node (e.g., network node 110) performs operations associated with collision handling for SBFD sets of symbols.

As shown in FIG. 9, in some aspects, process 900 may include transmitting, to a UE, configuration information that indicates CSI-RS resources that are within a downlink sub-band of an SBFD set of symbols, wherein the CSI-RS resources are associated with L1 measurements (block 910). For example, the network node (e.g., using transmission component 1204 or communication manager 1206, depicted in FIG. 12) may transmit, to a UE, configuration information that indicates CSI-RS resources that are within a downlink sub-band of an SBFD set of symbols, wherein the CSI-RS resources are associated with L1 measurements, as described above.

As further shown in FIG. 9, in some aspects, process 900 may include transmitting, to the UE, a first indication that the UE is to perform an uplink transmission in an uplink sub-band of the SBFD set of symbols (block 920). For example, the network node (e.g., using transmission component 1204 or communication manager 1206, depicted in FIG. 12) may transmit, to the UE, a first indication that the UE is to perform an uplink transmission in an uplink sub-band of the SBFD set of symbols, as described above.

As further shown in FIG. 9, in some aspects, process 900 may include receiving, from the UE and based at least in part on the configuration information and the first indication, one of the L1 measurements using the CSI-RS resources in the downlink sub-band of the SBFD set of symbols, or the uplink transmission using the uplink sub-band of the SBFD set of symbols (block 930). For example, the network node (e.g., using reception component 1202 or communication manager 1206, depicted in FIG. 12) may receive, from the UE and based at least in part on the configuration information and the first indication, one of the L1 measurements using the CSI-RS resources in the downlink sub-band of the SBFD set of symbols, or the uplink transmission using the uplink sub-band of the SBFD set of symbols, as described above.

Process 900 may include additional aspects, such as any single aspect or any combination of aspects described below or in connection with one or more other processes described elsewhere herein.

In a first aspect, process 900 includes transmitting, to the UE, a second indication that indicates whether the UE is to perform the L1 measurements or the uplink transmission, wherein receiving the one of the L1 measurements or the uplink transmission is based at least in part on the second indication.

In a second aspect, alone or in combination with the first aspect, process 900 includes receiving, from the UE, L1 measurement results associated with a set of symbols that precedes the SBFD set of symbols, wherein the second indication is based at least in part on the L1 measurement results associated with the set of symbols.

In a third aspect, alone or in combination with one or more of the first and second aspects, the configuration information further indicates criteria associated with the UE selectively performing the one of the L1 measurements or the uplink transmission, and receiving the one of the L1 measurements or the uplink transmission is based at least in part on the criteria.

In a fourth aspect, alone or in combination with one or more of the first through third aspects, the criteria are associated with an L1 measurement result, that is associated with a set of symbols that precedes the SBFD set of symbols, satisfying a threshold.

In a fifth aspect, alone or in combination with one or more of the first through fourth aspects, receiving the one of the L1 measurements or the uplink transmission is based at least in part on a predefined rule.

In a sixth aspect, alone or in combination with one or more of the first through fifth aspects, the predefined rule indicates that the UE is to selectively perform the uplink transmission.

In a seventh aspect, alone or in combination with one or more of the first through sixth aspects, receiving the one of the L1 measurements or the uplink transmission includes receiving the uplink transmission, and an L1 period is extended based at least in part on receiving the uplink transmission.

In an eighth aspect, alone or in combination with one or more of the first through seventh aspects, the L1 period is extended by a multiple of a CSI-RS periodicity.

In a ninth aspect, alone or in combination with one or more of the first through eighth aspects, receiving the one of the L1 measurements or the uplink transmission includes receiving the L1 measurements based at least in part on a predefined rule, and the predefined rule indicates one or more uplink transmission types that are prohibited from overlapping with the CSI-RS resources.

In a tenth aspect, alone or in combination with one or more of the first through ninth aspects, the one or more uplink transmission types that are prohibited from overlapping with the CSI-RS resources are associated with at least one of a physical-uplink-control-channel-based transmission, a physical-uplink-shared-channel-based transmission, or a sounding reference signal transmission.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node. Example process 1000 is an example where the apparatus or the network node (e.g., network node 110) performs operations associated with CSI-RS measurements across SBFD symbols and non-SBFD symbols.

As shown in FIG. 10, in some aspects, process 1000 may include transmitting, to a UE, configuration information that indicates a CSI-RS resource configuration that indicates resources for performing CSI-RS measurements, and an SBFD transmit/reception configuration that indicates whether the UE is to transmit or receive communications across SBFD symbols and non-SBFD symbols (block 1010). For example, the network node (e.g., using transmission component 1204 or communication manager 1206, depicted in FIG. 12) may transmit, to a UE, configuration information that indicates a CSI-RS resource configuration that indicates resources for performing CSI-RS measurements, and an SBFD transmit/reception configuration that indicates whether the UE is to transmit or receive communications across SBFD symbols and non-SBFD symbols, as described above.

As further shown in FIG. 10, in some aspects, process 1000 may include receiving, from the UE and based at least in part on the configuration information, CSI-RS measurement results associated with CSI-RS measurements using at least one of one or more non-SBFD symbols, or a downlink sub-band of one or more SBFD symbols (block 1020). For example, the network node (e.g., using reception component 1202 or communication manager 1206, depicted in FIG. 12) may receive, from the UE and based at least in part on the configuration information, CSI-RS measurement results associated with CSI-RS measurements using at least one of one or more non-SBFD symbols, or a downlink sub-band of one or more SBFD symbols, as described above.

Process 1000 may include additional aspects, such as any single aspect or any combination of aspects described below or in connection with one or more other processes described elsewhere herein.

In a first aspect, the SBFD transmit/reception configuration does not apply to the CSI-RS measurements based at least in part on a predefined rule.

In a second aspect, alone or in combination with the first aspect, the CSI-RS resources occur only in one or more non-SBFD symbols based at least in part on the predefined rule.

In a third aspect, alone or in combination with one or more of the first and second aspects, the CSI-RS resources occur in both the one or more non-SBFD symbols, and the downlink sub-band of the one or more SBFD symbols, based at least in part on the predefined rule.

In a fourth aspect, alone or in combination with one or more of the first through third aspects, the SBFD transmit/reception configuration indicates that the UE is to transmit or receive communications across SBFD symbols and non-SBFD symbols, and the process 1000 further comprises receiving the CSI-RS measurement results associated with the CSI-RS measurements using both the one or more non-SBFD symbols, and the downlink sub-band of the one or more SBFD symbols, based at least in part on the SBFD transmit/reception configuration indicating that the UE is to transmit or receive communications across SBFD symbols and non-SBFD symbols.

In a fifth aspect, alone or in combination with one or more of the first through fourth aspects, the SBFD transmit/reception configuration indicates that the UE is not to transmit or receive communications across SBFD symbols and non-SBFD symbols, and the process 1000 further comprises receiving the CSI-RS measurement results associated with the CSI-RS measurements using one of the one or more non-SBFD symbols, or the downlink sub-band of the one or more SBFD symbols, based at least in part on the SBFD transmit/reception configuration indicating that the UE is not to transmit or receive communications across SBFD symbols and non-SBFD symbols.

In a sixth aspect, alone or in combination with one or more of the first through fifth aspects, the configuration information further indicates the one of the one or more non-SBFD symbols, or the downlink sub-band of the one or more SBFD symbols, associated with the CSI-RS measurements.

In a seventh aspect, alone or in combination with one or more of the first through sixth aspects, the configuration information indicates the one of the one or more non-SBFD symbols, or the downlink sub-band of the one or more SBFD symbols, associated with the CSI-RS measurements via at least one of a first RRC parameter associated with a CSI-RS resource set configuration, a second RRC parameter associated with a CSI report configuration, or a third RRC parameter associated with a CSI measurement configuration.

In an eighth aspect, alone or in combination with one or more of the first through seventh aspects, process 1000 includes receiving, from the UE, capability information indicating UE support for performing CSI-RS measurements in accordance with the SBFD transmit/reception configuration, wherein the configuration information is based at least in part on the capability information.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 5A-6B. Additionally, or alternatively, the apparatus 1100 may be configured to perform one or more processes described herein, such as process 700 of FIG. 7, process 800 of FIG. 8, or a combination thereof. In some aspects, the apparatus 1100 or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The reception component 1102 may receive configuration information that indicates CSI-RS resources that are within a downlink sub-band of an SBFD set of symbols, wherein the CSI-RS resources are associated with L1 measurements. The reception component 1102 may receive a first indication that the UE is to perform an uplink transmission in an uplink sub-band of the SBFD set of symbols. The communication manager 1106 may selectively perform, based at least in part on the configuration information and the first indication, one of the L1 measurements using the CSI-RS resources in the downlink sub-band of the SBFD set of symbols, or the uplink transmission using the uplink sub-band of the SBFD set of symbols.

The reception component 1102 may receive a second indication that indicates whether the UE is to perform the L1 measurements or the uplink transmission, wherein selectively performing the one of the L1 measurements or the uplink transmission is based at least in part on the second indication.

The transmission component 1104 may transmit L1 measurement results associated with a set of symbols that precedes the SBFD set of symbols, wherein the second indication is based at least in part on the L1 measurement results associated with the set of symbols.

The reception component 1102 may receive configuration information that indicates a CSI-RS resource configuration that indicates resources for performing CSI-RS measurements, and an SBFD transmit/reception configuration that indicates whether the UE is to transmit or receive communications across SBFD symbols and non-SBFD symbols. The communication manager 1106 may perform, based at least in part on the configuration information, the CSI-RS measurements using at least one of one or more non-SBFD symbols, or a downlink sub-band of one or more SBFD symbols.

The transmission component 1104 may transmit capability information indicating UE support for performing CSI-RS measurements in accordance with the SBFD transmit/reception configuration, wherein the configuration information is based at least in part on the capability information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network node, or a network node may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 5A-6B. Additionally, or alternatively, the apparatus 1200 may be configured to perform one or more processes described herein, such as process 900 of FIG. 9, process 1000 of FIG. 10, or a combination thereof. In some aspects, the apparatus 1200 or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 or the transmission component 1204 may include or may be included in a network interface. The network interface may be configured to obtain or output signals for the apparatus 1200 via one or more communications links, such as a backhaul link, a midhaul link, or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

The transmission component 1204 may transmit, to a UE, configuration information that indicates CSI-RS resources that are within a downlink sub-band of an SBFD set of symbols, wherein the CSI-RS resources are associated with L1 measurements. The transmission component 1204 may transmit, to the UE, a first indication that the UE is to perform an uplink transmission in an uplink sub-band of the SBFD set of symbols. The reception component 1202 may receive, from the UE and based at least in part on the configuration information and the first indication, one of the L1 measurements using the CSI-RS resources in the downlink sub-band of the SBFD set of symbols, or the uplink transmission using the uplink sub-band of the SBFD set of symbols.

The transmission component 1204 may transmit, to the UE, a second indication that indicates whether the UE is to perform the L1 measurements or the uplink transmission, wherein receiving the one of the L1 measurements or the uplink transmission is based at least in part on the second indication.

The reception component 1202 may receive, from the UE, L1 measurement results associated with a set of symbols that precedes the SBFD set of symbols, wherein the second indication is based at least in part on the L1 measurement results associated with the set of symbols.

The transmission component 1204 may transmit, to a UE, configuration information that indicates a CSI-RS resource configuration that indicates resources for performing CSI-RS measurements, and an SBFD transmit/reception configuration that indicates whether the UE is to transmit or receive communications across SBFD symbols and non-SBFD symbols. The reception component 1202 may receive, from the UE and based at least in part on the configuration information, CSI-RS measurement results associated with CSI-RS measurements using at least one of one or more non-SBFD symbols, or a downlink sub-band of one or more SBFD symbols.

The reception component 1202 may receive, from the UE, capability information indicating UE support for performing CSI-RS measurements in accordance with the SBFD transmit/reception configuration, wherein the configuration information is based at least in part on the capability information.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving configuration information that indicates channel state information reference signal (CSI-RS) resources that are within a downlink sub-band of a sub-band full duplex (SBFD) set of symbols, wherein the CSI-RS resources are associated with layer 1 (L1) measurements; receiving a first indication that the UE is to perform an uplink transmission in an uplink sub-band of the SBFD set of symbols; and selectively performing, based at least in part on the configuration information and the first indication, one of: the L1 measurements using the CSI-RS resources in the downlink sub-band of the SBFD set of symbols, or the uplink transmission using the uplink sub-band of the SBFD set of symbols.

Aspect 2: The method of Aspect 1, further comprising receiving a second indication that indicates whether the UE is to perform the L1 measurements or the uplink transmission, wherein selectively performing the one of the L1 measurements or the uplink transmission is based at least in part on the second indication.

Aspect 3: The method of Aspect 2, further comprising transmitting L1 measurement results associated with a set of symbols that precedes the SBFD set of symbols, wherein the second indication is based at least in part on the L1 measurement results associated with the set of symbols.

Aspect 4: The method of any of Aspects 1-3, wherein the configuration information further indicates criteria associated with the UE selectively performing the one of the L1 measurements or the uplink transmission, and wherein selectively performing the one of the L1 measurements or the uplink transmission is based at least in part on the criteria.

Aspect 5: The method of Aspect 4, wherein the criteria are associated with an L1 measurement result, that is associated with a set of symbols that precedes the SBFD set of symbols, satisfying a threshold.

Aspect 6: The method of any of Aspects 1-5, wherein selectively performing the one of the L1 measurements or the uplink transmission is based at least in part on a predefined rule.

Aspect 7: The method of Aspect 6, wherein the predefined rule indicates that the UE is to selectively perform the uplink transmission.

Aspect 8: The method of any of Aspects 1-7, wherein selectively performing the one of the L1 measurements or the uplink transmission includes performing the uplink transmission, and wherein the method further comprises extending an L1 period based at least in part on performing the uplink transmission.

Aspect 9: The method of Aspect 8, wherein extending the L1 period includes extending the L1 period by a multiple of a CSI-RS periodicity.

Aspect 10: The method of any of Aspects 1-9, wherein selectively performing the one of the L1 measurements or the uplink transmission includes performing the L1 measurements based at least in part on a predefined rule, and wherein the predefined rule indicates one or more uplink transmission types that are prohibited from overlapping with the CSI-RS resources.

Aspect 11: The method of Aspect 10, wherein the one or more uplink transmission types that are prohibited from overlapping with the CSI-RS resources are associated with at least one of a physical-uplink-control-channel-based transmission, a physical-uplink-shared-channel-based transmission, or a sounding reference signal transmission.

Aspect 12: A method of wireless communication performed by a user equipment (UE), comprising: receiving configuration information that indicates: a channel state information reference signal (CSI-RS) resource configuration that indicates resources for performing CSI-RS measurements, and a sub-band full duplex (SBFD) transmit/reception configuration that indicates whether the UE is to transmit or receive communications across SBFD symbols and non-SBFD symbols; and performing, based at least in part on the configuration information, the CSI-RS measurements using at least one of one or more non-SBFD symbols, or a downlink sub-band of one or more SBFD symbols.

Aspect 13: The method of Aspect 12, wherein the SBFD transmit/reception configuration does not apply to the CSI-RS measurements based at least in part on a predefined rule.

Aspect 14: The method of Aspect 13, wherein the CSI-RS resources occur only in one or more non-SBFD symbols based at least in part on the predefined rule.

Aspect 15: The method of Aspect 13, wherein the CSI-RS resources occur in both the one or more non-SBFD symbols, and the downlink sub-band of the one or more SBFD symbols, based at least in part on the predefined rule.

Aspect 16: The method of any of Aspects 12-15, wherein the SBFD transmit/reception configuration indicates that the UE is to transmit or receive communications across SBFD symbols and non-SBFD symbols, and wherein the method further comprises performing the CSI-RS measurements using both the one or more non-SBFD symbols, and the downlink sub-band of the one or more SBFD symbols, based at least in part on the SBFD transmit/reception configuration indicating that the UE is to transmit or receive communications across SBFD symbols and non-SBFD symbols.

Aspect 17: The method of any of Aspects 12-16, wherein the SBFD transmit/reception configuration indicates that the UE is not to transmit or receive communications across SBFD symbols and non-SBFD symbols, and wherein the method further comprises performing the CSI-RS measurements using one of the one or more non-SBFD symbols, or the downlink sub-band of the one or more SBFD symbols, based at least in part on the SBFD transmit/reception configuration indicating that the UE is not to transmit or receive communications across SBFD symbols and non-SBFD symbols.

Aspect 18: The method of Aspect 17, wherein the configuration information further indicates the one of the one or more non-SBFD symbols, or the downlink sub-band of the one or more SBFD symbols, associated with the CSI-RS measurements.

Aspect 19: The method of Aspect 18, wherein the configuration information indicates the one of the one or more non-SBFD symbols, or the downlink sub-band of the one or more SBFD symbols, associated with the CSI-RS measurements via at least one of: a first radio resource control (RRC) parameter associated with a CSI-RS resource set configuration, a second RRC parameter associated with a CSI report configuration, or a third RRC parameter associated with a CSI measurement configuration.

Aspect 20: The method of any of Aspects 12-19, further comprising transmitting capability information indicating UE support for performing CSI-RS measurements in accordance with the SBFD transmit/reception configuration, wherein the configuration information is based at least in part on the capability information.

Aspect 21: A method of wireless communication performed by a network node, comprising: transmitting, to a user equipment (UE), configuration information that indicates channel state information reference signal (CSI-RS) resources that are within a downlink sub-band of a sub-band full duplex (SBFD) set of symbols, wherein the CSI-RS resources are associated with layer 1 (L1) measurements; transmitting, to the UE, a first indication that the UE is to perform an uplink transmission in an uplink sub-band of the SBFD set of symbols; and receiving, from the UE and based at least in part on the configuration information and the first indication, one of: the L1 measurements using the CSI-RS resources in the downlink sub-band of the SBFD set of symbols, or the uplink transmission using the uplink sub-band of the SBFD set of symbols.

Aspect 22: The method of Aspect 21, further comprising transmitting, to the UE, a second indication that indicates whether the UE is to perform the L1 measurements or the uplink transmission, wherein receiving the one of the L1 measurements or the uplink transmission is based at least in part on the second indication.

Aspect 23: The method of Aspect 22, further comprising receiving, from the UE, L1 measurement results associated with a set of symbols that precedes the SBFD set of symbols, wherein the second indication is based at least in part on the L1 measurement results associated with the set of symbols.

Aspect 24: The method of any of Aspects 21-23, wherein the configuration information further indicates criteria associated with the UE selectively performing the one of the L1 measurements or the uplink transmission, and wherein receiving the one of the L1 measurements or the uplink transmission is based at least in part on the criteria.

Aspect 25: The method of Aspect 24, wherein the criteria are associated with an L1 measurement result, that is associated with a set of symbols that precedes the SBFD set of symbols, satisfying a threshold.

Aspect 26: The method of any of Aspects 21-25, wherein receiving the one of the L1 measurements or the uplink transmission is based at least in part on a predefined rule.

Aspect 27: The method of Aspect 26, wherein the predefined rule indicates that the UE is to selectively perform the uplink transmission.

Aspect 28: The method of any of Aspects 21-27, wherein receiving the one of the L1 measurements or the uplink transmission includes receiving the uplink transmission, and wherein an L1 period is extended based at least in part on receiving the uplink transmission.

Aspect 29: The method of Aspect 28, wherein the L1 period is extended by a multiple of a CSI-RS periodicity.

Aspect 30: The method of any of Aspects 21-29, wherein receiving the one of the L1 measurements or the uplink transmission includes receiving the L1 measurements based at least in part on a predefined rule, and wherein the predefined rule indicates one or more uplink transmission types that are prohibited from overlapping with the CSI-RS resources .

Aspect 31: The method of Aspect 30, wherein the one or more uplink transmission types that are prohibited from overlapping with the CSI-RS resources are associated with at least one of a physical-uplink-control-channel-based transmission, a physical-uplink-shared-channel-based transmission, or a sounding reference signal transmission.

Aspect 32: A method of wireless communication performed by a network node, comprising: transmitting, to a user equipment (UE), configuration information that indicates: a channel state information reference signal (CSI-RS) resource configuration that indicates resources for performing CSI-RS measurements, and a sub-band full duplex (SBFD) transmit/reception configuration that indicates whether the UE is to transmit or receive communications across SBFD symbols and non-SBFD symbols; and receiving, from the UE and based at least in part on the configuration information, CSI-RS measurement results associated with CSI-RS measurements using at least one of one or more non-SBFD symbols, or a downlink sub-band of one or more SBFD symbols.

Aspect 33: The method of Aspect 32, wherein the SBFD transmit/reception configuration does not apply to the CSI-RS measurements based at least in part on a predefined rule.

Aspect 34: The method of Aspect 33, wherein the CSI-RS resources occur only in one or more non-SBFD symbols based at least in part on the predefined rule.

Aspect 35: The method of Aspect 33, wherein the CSI-RS resources occur in both the one or more non-SBFD symbols, and the downlink sub-band of the one or more SBFD symbols, based at least in part on the predefined rule.

Aspect 36: The method of any of Aspects 32-35, wherein the SBFD transmit/reception configuration indicates that the UE is to transmit or receive communications across SBFD symbols and non-SBFD symbols, and wherein the method further comprises receiving the CSI-RS measurement results associated with the CSI-RS measurements using both the one or more non-SBFD symbols, and the downlink sub-band of the one or more SBFD symbols, based at least in part on the SBFD transmit/reception configuration indicating that the UE is to transmit or receive communications across SBFD symbols and non-SBFD symbols.

Aspect 37: The method of any of Aspects 32-36, wherein the SBFD transmit/reception configuration indicates that the UE is not to transmit or receive communications across SBFD symbols and non-SBFD symbols, and wherein the method further comprises receiving the CSI-RS measurement results associated with the CSI-RS measurements using one of the one or more non-SBFD symbols, or the downlink sub-band of the one or more SBFD symbols, based at least in part on the SBFD transmit/reception configuration indicating that the UE is not to transmit or receive communications across SBFD symbols and non-SBFD symbols.

Aspect 38: The method of Aspect 37, wherein the configuration information further indicates the one of the one or more non-SBFD symbols, or the downlink sub-band of the one or more SBFD symbols, associated with the CSI-RS measurements.

Aspect 39: The method of Aspect 38, wherein the configuration information indicates the one of the one or more non-SBFD symbols, or the downlink sub-band of the one or more SBFD symbols, associated with the CSI-RS measurements via at least one of: a first radio resource control (RRC) parameter associated with a CSI-RS resource set configuration, a second RRC parameter associated with a CSI report configuration, or a third RRC parameter associated with a CSI measurement configuration.

Aspect 40: The method of any of Aspects 32-39, further comprising receiving, from the UE, capability information indicating UE support for performing CSI-RS measurements in accordance with the SBFD transmit/reception configuration, wherein the configuration information is based at least in part on the capability information.

Aspect 41: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-40.

Aspect 42: An apparatus for wireless communication at a device, the apparatus comprising one or more memories and one or more processors coupled to the one or more memories, the one or more processors configured to cause the device to perform the method of one or more of Aspects 1-40.

Aspect 43: An apparatus for wireless communication, the apparatus comprising at least one means for performing the method of one or more of Aspects 1-40.

Aspect 44: A non-transitory computer-readable medium storing code for wireless communication, the code comprising instructions executable by one or more processors to perform the method of one or more of Aspects 1-40.

Aspect 45: A non-transitory computer-readable medium storing a set of instructions for wireless communication, the set of instructions comprising one or more instructions that, when executed by one or more processors of a device, cause the device to perform the method of one or more of Aspects 1-40.

Aspect 46: A device for wireless communication, the device comprising a processing system that includes one or more processors and one or more memories coupled with the one or more processors, the processing system configured to cause the device to perform the method of one or more of Aspects 1-40.

Aspect 47: An apparatus for wireless communication at a device, the apparatus comprising one or more memories and one or more processors coupled to the one or more memories, the one or more processors individually or collectively configured to cause the device to perform the method of one or more of Aspects 1-40.

Aspect 48: A device comprising a processing system that includes one or more processors and one or more code-storing memories coupled with the one or more processors, the processing system configured to cause the device to perform the method of one or more of Aspects 1-40.

Aspect 49: A device comprising a processing system that includes processor circuitry and code-storing memory circuitry, the processing system configured to cause the device to perform the method of one or more of Aspects 1-40.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive configuration information that indicates channel state information reference signal (CSI-RS) resources that are within a downlink sub-band of a sub-band full duplex (SBFD) set of symbols, wherein the CSI-RS resources are associated with layer 1 (L1) measurements;
receive a first indication that the UE is to perform an uplink transmission in an uplink sub-band of the SBFD set of symbols; and
selectively perform, based at least in part on the configuration information and the first indication, one of:
the L1 measurements using the CSI-RS resources in the downlink sub-band of the SBFD set of symbols, or
the uplink transmission using the uplink sub-band of the SBFD set of symbols.

2. The UE of claim 1, wherein the processing system, to cause the UE to selectively perform the one of the L1 measurements or the uplink transmission, is configured to cause the UE to selectively perform the one of the L1 measurements or the uplink transmission based at least in part on a predefined rule.

3. The UE of claim 2, wherein the predefined rule indicates that the UE is to selectively perform the uplink transmission.

4. The UE of claim 1, wherein the processing system, to cause the UE to selectively perform the one of the L1 measurements or the uplink transmission, is configured to cause the UE to perform the uplink transmission, and
wherein the processing system is further configured to cause the UE to extend an L1 period based at least in part on causing the UE to perform the uplink transmission.

5. The UE of claim 4, wherein the processing system, to cause the UE to extend the L1 period, is configured to cause the UE to extend the L1 period by a multiple of a CSI-RS periodicity.

6. The UE of claim 1, wherein the processing system, to cause the UE to selectively perform the one of the L1 measurements or the uplink transmission, is configured to cause the UE to perform the L1 measurements based at least in part on a predefined rule, and
wherein the predefined rule indicates one or more uplink transmission types that are prohibited from overlapping with the CSI-RS resources.

7. The UE of claim 6, wherein the one or more uplink transmission types that are prohibited from overlapping with the CSI-RS resources are associated with at least one of a physical-uplink-control-channel-based transmission, a physical-uplink-shared-channel-based transmission, or a sounding reference signal transmission.

8. A user equipment (UE), comprising:
a processing system that includes one or more processors and one or more code-storing memories coupled with the one or more processors, the processing system configured to cause the UE to:
receive configuration information that indicates:
a channel state information reference signal (CSI-RS) resource configuration that indicates resources for performing CSI-RS measurements, and
a sub-band full duplex (SBFD) transmit/reception configuration that indicates whether the UE is to transmit or receive communications across SBFD symbols and non-SBFD symbols; and
perform, based at least in part on the configuration information, the CSI-RS measurements using at least one of one or more non-SBFD symbols, or a downlink sub-band of one or more SBFD symbols.

9. The UE of claim 8, wherein the SBFD transmit/reception configuration does not apply to the CSI-RS measurements based at least in part on a predefined rule.

10. The UE of claim 9, wherein the CSI-RS resources occur only in one or more non-SBFD symbols based at least in part on the predefined rule.

11. The UE of claim 9, wherein the CSI-RS resources occur in both the one or more non-SBFD symbols, and the downlink sub-band of the one or more SBFD symbols, based at least in part on the predefined rule.

12. The UE of claim 8, wherein the SBFD transmit/reception configuration indicates that the UE is to transmit or receive communications across SBFD symbols and non-SBFD symbols, and
wherein the processing system is further configured to cause the UE to perform the CSI-RS measurements using both the one or more non-SBFD symbols, and the downlink sub-band of the one or more SBFD symbols, based at least in part on the SBFD transmit/reception configuration indicating that the UE is to transmit or receive communications across SBFD symbols and non-SBFD symbols.

13. The UE of claim 8, wherein the SBFD transmit/reception configuration indicates that the UE is not to transmit or receive communications across SBFD symbols and non-SBFD symbols, and
wherein the processing system is further configured to cause the UE to perform the CSI-RS measurements using one of the one or more non-SBFD symbols, or the downlink sub-band of the one or more SBFD symbols, based at least in part on the SBFD transmit/reception configuration indicating that the UE is not to transmit or receive communications across SBFD symbols and non-SBFD symbols.

14. The UE of claim 13, wherein the configuration information further indicates the one of the one or more non-SBFD symbols, or the downlink sub-band of the one or more SBFD symbols, associated with the CSI-RS measurements.

15. The UE of claim 14, wherein the configuration information indicates the one of the one or more non-SBFD symbols, or the downlink sub-band of the one or more SBFD symbols, associated with the CSI-RS measurements via at least one of:
a first radio resource control (RRC) parameter associated with a CSI-RS resource set configuration,
a second RRC parameter associated with a CSI report configuration, or
a third RRC parameter associated with a CSI measurement configuration.

16. A method of wireless communication performed by a user equipment (UE), comprising:
receiving configuration information that indicates channel state information reference signal (CSI-RS) resources that are within a downlink sub-band of a sub-band full duplex (SBFD) set of symbols, wherein the CSI-RS resources are associated with layer 1 (L1) measurements;
receiving a first indication that the UE is to perform an uplink transmission in an uplink sub-band of the SBFD set of symbols; and
selectively performing, based at least in part on the configuration information and the first indication, one of:
the L1 measurements using the CSI-RS resources in the downlink sub-band of the SBFD set of symbols, or
the uplink transmission using the uplink sub-band of the SBFD set of symbols.

17. The method of claim 16, wherein selectively performing the one of the L1 measurements or the uplink transmission is based at least in part on a predefined rule.

18. The method of claim 17, wherein the predefined rule indicates that the UE is to selectively perform the uplink transmission.

19. The method of claim 16, wherein selectively performing the one of the L1 measurements or the uplink transmission includes performing the uplink transmission, and
wherein the method further comprises extending an L1 period based at least in part on performing the uplink transmission.

20. The method of claim 19, wherein extending the L1 period includes extending the L1 period by a multiple of a CSI-RS periodicity.
